(19) United States
(12) Patent Application Publication
(10) Pub. No.: US 2013/0301789 A1
(43) Pub. Date: Nov. 14, 2013

(54) REACTOR COOLANT PUMP SYSTEM WITH ANNULAR FLOW TURBO PUMP

(71) Applicant: Babcock & Wilcox Power Generation Group, Inc., (US)

(72) Inventor: Robert T. FORTINO, Canton, OH (US)

(21) Appl. No.: 13/863,121

(22) Filed: Apr. 15, 2013

Related U.S. Application Data
(60) Provisional application No. 61/624,453, filed on Apr. 16, 2012.
(60) Provisional application No. 61/624,966, filed on Apr. 16, 2012.

(51) Int. Cl. G21C 15/25

(52) U.S. Cl. CPC G21C 15/25
USPC 376/392

(57) ABSTRACT

A reactor coolant pump (RCP) generates primary coolant flow in a nuclear reactor. The RCP includes a flow amplification device, such as a turbo pump, disposed in the pressure vessel of the nuclear reactor, and an electrically driven pump (e.g. a centrifugal pump). The inlet of the electrically driven pump receives primary coolant water from the pressure vessel and the outlet discharges into the driving inlet of the flow amplification device (e.g. into the turbine of a turbo pump) such that the centrifugal pump drives the flow amplification device to pump primary coolant water. A divider is disposed in the pressure vessel and separates the pumping inlet of the flow amplification device from the pumping outlet of the flow amplification device. The electrically driven pump may include hydraulic drive shaft bearings and starting mechanical drive shaft bearings that disengage at operating speed due to axial shift of the drive shaft.

This application claims the benefit of U.S. Provisional Application No. 61/624,453 filed Apr. 16, 2012 and titled “REACTOR COOLANT PUMP SYSTEMS”. U.S. Provisional Application No. 61/624,453 filed Apr. 16, 2012 and titled “REACTOR COOLANT PUMP SYSTEMS” is hereby incorporated by reference in its entirety into the specification of this application.

This application claims the benefit of U.S. Provisional Application No. 61/624,966 filed Apr. 16, 2012 and titled “COOLANT PUMP APPARATUSES AND METHODS OF USE FOR SMRS”. U.S. Provisional Application No. 61/624,966 filed Apr. 16, 2012 and titled “COOLANT PUMP APPARATUSES AND METHODS OF USE FOR SMRS” is hereby incorporated by reference in its entirety into the specification of this application.

### BACKGROUND

The following relates to the nuclear reactor arts, nuclear power generation arts, nuclear reactor hydrodynamic design arts, and related arts.

In nuclear reactor designs of the pressurized water reactor (PWR) type, a radioactive nuclear reactor core is immersed in primary coolant water at or near the bottom of a pressure vessel. The primary coolant is maintained in a compressed or subcooled liquid phase. In applications in which steam generation is desired, the primary coolant water is flowed out of the pressure vessel, into an external steam generator where it heats secondary coolant water flowing in a separate secondary coolant path, and back into the pressure vessel. Alternatively, an internal steam generator is located inside the pressure vessel (sometimes called an “integral PWR” design), and the secondary coolant is flowed into the pressure vessel within a separate secondary coolant path in the internal steam generator. In either design, heated primary coolant water heats secondary coolant water in the steam generator to convert the secondary coolant water into steam. An advantage of the PWR design is that the steam comprises secondary coolant water that is not exposed to the radioactive reactor core.

In a typical PWR design configuration, the primary coolant flow circuit is defined by a cylindrical pressure vessel that is mounted generally upright (that is, with its cylinder axis oriented vertically). A hollow cylindrical central riser is disposed concentrically inside the pressure vessel. Primary coolant flows upward through the reactor core where it is heated and rises through the central riser, discharges from the top of the central riser and reverses direction to flow downward back toward the reactor core through a downcomer. In an integral PWR, the downward flow is through a downcomer annulus defined between the pressure vessel and the central riser. This is a natural convection flow circuit that can, in principle, be driven by heat injection from the reactor core and cooling of the primary coolant as it passes through the steam generator. However, for higher power reactors it is advantageous or even necessary to supplement or supplant the natural convection with motive force provided by electromechanical reactor coolant pumps.

Most commercial PWR systems employ external steam generators. In such systems, the primary coolant water is pumped by an external pump connected with external piping running between the PWR pressure vessel and the external steam generator. This also provides motive force for circulating the primary coolant water within the pressure vessel, since the pumps drive the entire primary coolant flow circuit including the portion within the pressure vessel.

Fewer commercial “integral” PWR systems employing an internal steam generator have been produced. One contemplated approach is to adapt a reactor coolant pump of the type used in a boiling water reactor (BWR) for use in the integral PWR. Such arrangements have the advantages of good heat management (because the pump motor is located externally) and maintenance convenience (because the externally located pump is readily removed for repair or replacement).

However, the coupling of the external reactor coolant pump with the interior of the pressure vessel introduces vessel penetrations that, at least potentially, can be the location of a loss of coolant accident (LOCA).

Another disadvantage of existing reactor coolant pumps is that the pump operates in an inefficient fashion. Effective primary coolant circulation in an integral PWR calls for a pump providing high flow volume with a relatively low pressure head (i.e., pressure difference between pump inlet and outlet). In contrast, most commercially available reactor coolant pumps operate most efficiently at a substantially higher pressure head than that existing in the primary coolant flow circuit and provide an undesirably low pumped flow volume.

Yet another disadvantage of existing reactor coolant pumps is that natural primary coolant circulation is disrupted as the primary coolant path is diverted to the external reactor coolant pumps. This can be problematic for emergency core cooling systems (EGGS) that rely upon natural circulation of the primary coolant to provide passive core cooling in the event of a failure of the reactor coolant pumps.

Another contemplated approach is to employ self-contained internal reactor coolant pumps in which the pump motor is located with the impeller inside the pressure vessel. However, in this arrangement the pump motors must be designed to operate inside the pressure vessel, which is a difficult high temperature and possibly caustic environment (e.g., the primary coolant may include dissolved boric acid). Electrical penetrations into the pressure vessel are introduced in order to operate the internal pumps. Pump maintenance is complicated by the internal placement of the pumps, and maintenance concerns are amplified by an anticipated increase in pump motor failure rates due to the difficult environment inside the pressure vessel. Still further, the internal pumps occupy valuable space inside the pressure vessel.

Disclosed herein are improvements that provide various benefits that will become apparent to the skilled artisan upon reading the following.

### BRIEF SUMMARY

In one aspect of the disclosure, a nuclear reactor includes a nuclear core comprising a fissile material and a pressure vessel containing the nuclear core immersed in primary coolant water. A reactor coolant pump (RCP) generates primary coolant flow. The RCP includes a flow amplification device disposed in the pressure vessel and an electrically driven centrifugal pump. The flow amplification device has a driving inlet, a pumping inlet, and a pumping outlet. The electrically driven centrifugal pump has an inlet receiving primary coolant water from the pressure vessel and an outlet discharging into the driving inlet of the flow amplification device such that the centrifugal pump drives the flow amplification device to pump primary coolant water from the pumping inlet to the pumping outlet. A divider is disposed in the pressure vessel and separates the pumping inlet of the flow amplification device from the pumping outlet of the flow amplification device.

In another aspect of the disclosure, an apparatus includes a nuclear core comprising a fissile material, a pressure vessel containing the nuclear core immersed in primary coolant water, and an electrically driven pump including an electric motor operatively connected by a drive shaft with an impeller arranged to pump primary coolant water. The electric motor of the electrically driven pump has at least one hydraulic bearing operating on the drive shaft.

In another aspect of the disclosure, an apparatus includes a nuclear core comprising a fissile material, a pressure vessel containing the nuclear core immersed in primary coolant water, and a reactor coolant pump (RCP) generating primary coolant flow. The RCP includes: a flow amplification device disposed in the pressure vessel, the flow amplification device having a driving inlet, a pumping inlet, and a pumping outlet; and an electrically driven pump having an inlet receiving primary coolant water from the pressure vessel and an outlet discharging into the driving inlet of the flow amplification device such that the electrically driven pump drives the flow amplification device to pump primary coolant water from the pumping inlet to the pumping outlet. The apparatus further includes a manifold plenum chamber disposed in the pressure vessel and separating the pumping inlet of the flow amplification device from the pumping outlet of the flow amplification device. The manifold plenum of the manifold plenum chamber is in fluid communication with the pumping inlet of the flow amplification device.

### BRIEF DESCRIPTION OF THE DRAWINGS

The invention may take form in various components and arrangements of components, and in various process operations and arrangements of process operations. The drawings are only for purposes of illustrating preferred embodiments and are not to be construed as limiting the invention.

FIG. 1 diagrammatically shows a nuclear reactor including a reactor coolant pump (RCP) as disclosed herein.

FIG. 2 diagrammatically shows the operation of the RCP of FIG. 1.

FIG. 3 is a simplified diagram of the RCP and turbo pump of FIG. 1.

FIG. 4 is a detailed diagram of the RCP and turbo pump of FIG. 1.

FIG. 5 shows two turbo pumps mounted in a manifold.

FIG. 6 shows the manifold of FIG. 5.

FIG. 7 shows the internals of the manifold of FIG. 6

FIG. 8 shows a lip of the turbo pump housing.

FIG. 9 shows the internals of a turbo pump.

FIG. 10 shows the outside of the rotating barrel assembly of the turbo pump.

FIG. 11 shows the inside of the rotating barrel assembly of the turbo pump.

FIG. 12 shows the fixed vanes of the turbo pump.

FIG. 13 shows a lower assembly of the turbo pump.

FIG. 14 shows the manifold of FIG. 5 mounted in the gussets of a nuclear reactor vessel.

FIG. 15 shows the arrangement of the hydraulic reactor coolant pumps around the reactor vessel.

FIG. 16 shows the inlet scoop for the impeller of the RCP.

FIGS. 17 and 18 are a cutaway view of the inlet scoop and impeller of FIG. 16.

FIG. 19 is a detailed view of the inlet scoop.

FIGS. 20 and 21 show the impeller housing of the RCP.

FIGS. 22(a) and 22(b) show a rear bracket for the impeller of the RCP.

FIG. 23 is a bolt that passes through the reactor vessel and houses the shaft of the RCP.

FIG. 24 depicts an exemplary RCP.

FIGS. 25 and 26 show the impeller of the RCP.

FIG. 27 is an embodiment of the RCP with the impeller outside of the reactor vessel.

FIG. 28 is a detailed view of the embodiment of FIG. 27.

FIG. 29 is a cutaway of the axial inlet/outlet header and RCP of FIG. 28.

FIGS. 30-32 are different views of the head of the RCP of FIG. 28.

FIG. 33 is a cutaway view of the RCP and impeller of FIG. 28.

FIG. 34 is a cutaway view of the RCP of FIG. 28 showing a front and rear mechanical bearing.

FIGS. 35(a) and 35(b) are cutaway views of the front bearing of the RCP in a startup/shutdown and normal operating condition.

FIG. 36 is a cutaway view of the rear bearing assembly of the RCP.

FIGS. 37(a) and 37(b) are cutaway views of the rear bearing of the RCP in a startup/shutdown and normal operating condition.

FIG. 38 is the shaft of the RCP.

### DETAILED DESCRIPTION OF THE PREFERRED EMBODIMENTS

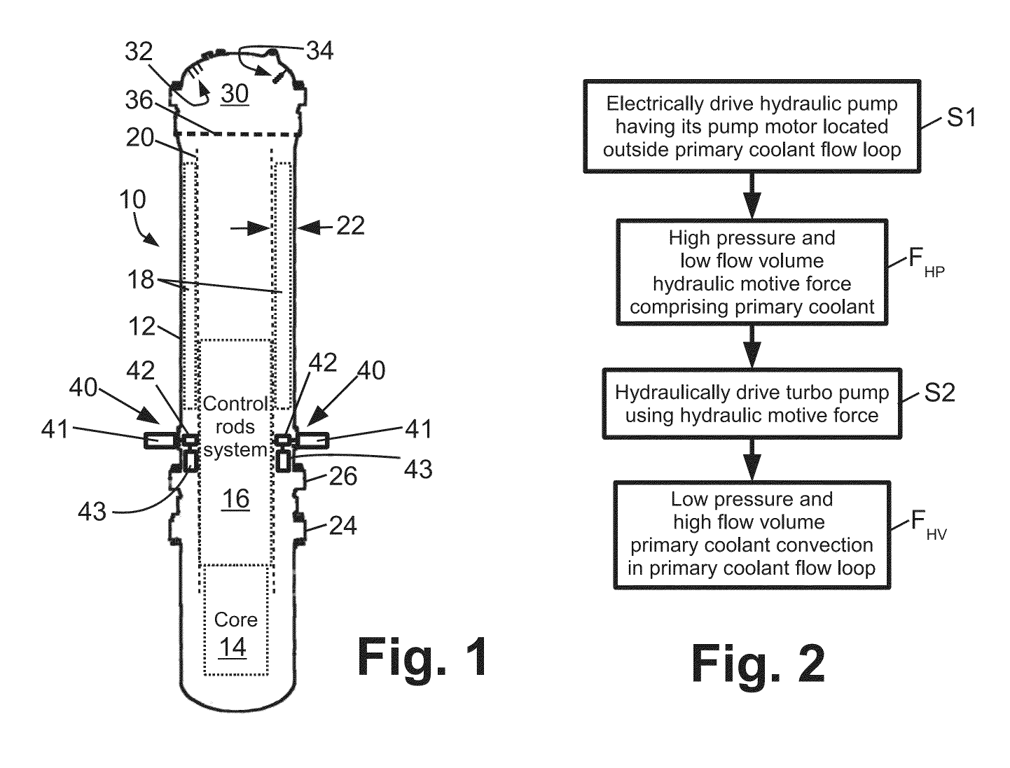

With reference to FIG. 1, an illustrative nuclear reactor of the pressurized water reactor (PWR) type 10 includes a pressure vessel 12, which in the illustrative embodiment is a cylindrical vertically mounted vessel. As used herein, the phrase “cylindrical pressure vessel” or similar phraseology indicates that the pressure vessel has a generally cylindrical shape, but may in some embodiments deviate from a mathematically perfect cylinder. For example, the illustrative cylindrical pressure vessel 12 has a circular cross-section of varying diameter along the length of the cylinder, and has rounded ends, and includes various vessel penetrations, vessel section flange connections, and so forth. Similarly, although the pressure vessel 12 is upright, it is contemplated for this upright position to deviate from exact vertical orientation of the cylinder axis. For example, if the PWR is disposed in a maritime vessel then it may be upright but with some tilt, which may vary with time, due to movement of the maritime vessel on or beneath the water.

Selected components of the PWR that are internal to the pressure vessel 12 are shown diagrammatically in phantom (that is, by dotted lines). A nuclear reactor core 14 is disposed in a lower portion of the pressure vessel 12. The reactor core 14 includes a mass of fissile material, such as a material containing uranium oxide (UO₂) that is enriched in the fissile ²³⁵U isotope, in a suitable matrix material. In a typical configuration, the fissile material is arranged as fuel rods arranged in a core basket. The pressure vessel 12 contains primary coolant water (typically light water, that is, H₂O, although heavy water, that is, D₂O, is also contemplated) in a subcooled state.

A control rods system 16 is mounted above the reactor core 14 and includes control rod drive mechanism (CRDM) units and control rod guide structures configured to precisely and controllably insert or withdraw control rods into or out of the reactor core 14. The illustrative control rods system 16 employs internal CRDM units that are disposed inside the pressure vessel 12. Some illustrative examples of suitable internal CRDM designs include: Stambaugh et al., “Control Rod Drive Mechanism for Nuclear Reactor”, U.S. Pub. No. 2010/0316177 A1 published Dec. 16, 2010 which is incorporated herein by reference in its entirety; and Stambaugh et al., “Control Rod Drive Mechanism for Nuclear Reactor”, Intl Pub. WO 2010/144563 A1 published Dec. 16, 2010 which is incorporated herein by reference in its entirety. In general, the control rods contain neutron absorbing material, and reactivity is increased by withdrawing the control rods or decreased by inserting the control rods. So-called “gray” control rods are continuously adjustable to provide incremental adjustments of the reactivity. So-called “shutdown” control rods are designed to be inserted as quickly as feasible into the reactor core to shut down the nuclear reaction in the event of an emergency. Various hybrid control rod designs are also known. For example, a gray rod may include a mechanism for releasing the control rod in an emergency so that it falls into the reactor core 14 thus implementing a shutdown rod functionality. Internal CRDM designs have advantages in terms of compactness and reduction in mechanical penetrations of the pressure vessel 12; however, it is also contemplated to employ a control rods system including external CRDM located outside of (e.g., above) the pressure vessel and operatively connected with the control rods by connecting rods that pass through suitable mechanical penetrations into the pressure vessel.

The illustrative PWR 10 is an integral PWR, and includes an internal steam generator 18 disposed inside the pressure vessel 12. In the illustrative configuration, a central riser 20 is a cylindrical element disposed coaxially inside the cylindrical pressure vessel 12. (Again, the term “cylindrical” is intended to encompass generally cylindrical risers that deviate from a perfect cylinder by variations in diameter along the cylinder axis, inclusion of selected openings, or so forth). The riser 20 surrounds the control rods system 16 and extends upward, such that primary coolant water heated by the operating nuclear reactor core 14 rises upward through the central riser 20 toward the top of the pressure vessel, where it discharges, reverses flow direction and flows downward through an outer annulus defined between the central riser 20 and the cylindrical wall of the pressure vessel 12. The illustrative steam generator 18 is an annular steam generator disposed in a downcomer annulus 22 defined between the central riser 20 and the wall of the pressure vessel 12. The steam generator 18 provides independent but proximate flow paths for downwardly flowing primary coolant and upwardly flowing secondary coolant. The secondary coolant enters at a feedwater inlet 24, flows upward through the steam generator 18 where it is heated by the proximate downwardly flowing primary coolant to be converted to steam, and the steam discharges at a steam outlet 26.

FIG. 1 does not illustrate the detailed structure of the steam generator 18 or the secondary coolant flow path. For example, feedwater inlet tubes and/or a feedwater plenum convey feedwater from the inlet 24 to the bottom of the steam generator 18, and steam outlet tubes and/or a steam plenum convey steam from the top of the steam generator 18 to the steam outlet 26. Typically, the steam generator comprises steam generator tubes and a surrounding volume (or “shell”) containing the tubes, thus providing two proximate flow paths that are in fluid isolation from each other. In some embodiments, the primary coolant flows downward through the steam generator tubes (that is, “tube-side”) while the secondary coolant flows upward through the surrounding volume (that is, “shell-side”). In other embodiments, the primary coolant flows downward through the surrounding volume (shell-side) while the secondary coolant flows upward through the steam generator tubes (tube-side). In either configuration, the steam generator tubes can have various geometries, such as vertical straight tubes (sometimes referred to as a straight-tube once-through steam generator or “OTSG”), helical tubes encircling the central riser 20 (some embodiments of which are described, by way of illustrative example, in Thome et al., “Integral Helical Coil Pressurized Water Nuclear Reactor”, U.S. Pub. No. 2010/0316181 A1 published Dec. 16, 2010 which is incorporated herein by reference in its entirety), or so forth.

The pressure vessel 12 defines a sealed volume that, when the PWR is operational, contains primary coolant water in a subcooled state. Toward this end, the PWR includes an internal pressurizer volume 30 disposed at the top of the pressure vessel 12 containing a steam bubble whose pressure controls the pressure of the primary coolant water in the pressure vessel 12. The pressure is controlled by suitable devices such as a heater 32 (e.g., one or more resistive heaters) that heats the steam to increase pressure, and/or a sparger 34 that injects cool water or steam into the steam bubble to reduce pressure. A baffle plate 36 separates the internal pressurizer volume 30 from the remainder of the sealed volume of the pressure vessel 10. By way of illustrative example, in some embodiments the primary coolant pressure in the sealed volume of the pressure vessel 12 is at a pressure of about 2000 psia and at a temperature of about 300° C. (cold leg just prior to flowing into the reactor core 14) to 320° C. (hot leg just after discharge from the reactor core 14). These are merely illustrative subcooled conditions, and a diverse range of other operating pressures and temperatures are also contemplated. Moreover, the illustrative internal pressurizer can be replaced by an external pressurizer connected with the pressure vessel by suitable piping or other fluid connections.

A reactor coolant pump (RCP) 40 is configured to drive circulation of primary coolant water in the pressure vessel 12. In one embodiment, the reactor coolant pump motor 41 drives a centrifugal pump impeller 42 which takes in a small portion of coolant from the reactor coolant system (RCS) and provides hydraulic power (comprising pressurized reactor coolant) to a flow amplification pump. In one embodiment, the flow amplification pump is a turbo pump 43, although it is also contemplated that another type of flow amplification pump could be used, such as a jet pump as described in U.S. patent application Ser. No. 13/862,742 filed on Apr. 15, 2013. The flow amplification device has a driving inlet and a driving outlet. A driving fluid flow passes from the driving inlet to the driving outlet and is coupled, mechanically or hydraulically, to a pumped flow that flows from a pumping inlet to a pumping outlet. The small high pressure flow through the driving portion of the pump drives a higher volume through the pumping portion of the flow amplification device. A turbo pump 43 is an annular flow pump, comprising a housing containing a cylindrical barrel, the barrel having inside turbine blades and outside impeller blades constructed as a unitary rotating barrel element. This rotating barrel is enclosed in the housing forming an annulus around the outside of the impeller blades. This is merely an illustrative example, and other turbo pump configurations are also contemplated. In some embodiments the driving outlet and the pumping outlet are integrated in that a single outlet discharges both the driving flow and the pumping flow.

The electrically driven centrifugal pump impeller 42 creates axial flow through the inner turbine of the barrel, which rotates. The outside impeller blades, being rigidly attached to the barrel, rotate with the barrel, circulating the main portion of the reactor coolant downward through the downcomer annulus 22. The inner turbine functions as the driving portion of the turbo pump. The impeller of the turbo pump functions as the pumping portion.

With reference to FIG. 2, operation of the reactor coolant pump (RCP) 40 is described. In an operation S1, the hydraulic pump impeller 42 is electrically driven. The term “hydraulic pump” is used to indicate the electrically driven pump, as opposed to the flow amplification pump. The pump motor 41 of the hydraulic pump 42 is located outside the primary coolant flow loop, which has an advantage in that it is not exposed to the high temperature (e.g., 300-320° C. in some embodiments, although higher or lower coolant temperature is also contemplated) of the primary coolant. The hydraulic pump 42 operates to pump the primary coolant. However, it directly pumps only a relatively small portion of the total volumetric primary coolant flow passing downward through the downcomer annulus 22. The pumping S1 performed by the hydraulic pump 42 produces a high pressure flow F_{HP} which however is a relatively low volume flow. In an operation S2, the flow amplification device acts as a flow transformer to convert the high pressure flow F_{HP} to a higher volume (but lower pressure) flow F_{HV}. In one embodiment, the flow amplification device is a turbo pump 43, including a turbine and impeller. That is, in the operation S2 the high pressure flow F_{HP} drives the turbine blades which are mechanically coupled to the impeller blades, and the impeller blades generate the high volume flow F_{HV} which flows in the primary coolant flow loop (e.g., down the downcomer annulus 22).

Two illustrative embodiments of the RCP 40 are disclosed below: one which uses a centrifugal impeller internal to the reactor vessel on a drive shaft that penetrates the reactor vessel (shown in FIG. 1) and one which uses a centrifugal impeller external to the reactor vessel. Both implementations place the reactor coolant pump motor 41 outside of the reactor vessel. While a single RCP is illustrated for each embodiment, it is to be appreciated that there are typically an array of RCPs 40, e.g. N pumps spaced apart at 360°/N intervals around the downcomer annulus 22. The reactor coolant pumping system may also include a pump plate or other structural elements (not shown in FIG. 1) that separate the suction and discharge sides of the RCP 40, and that optionally also provide mounting points for mounting the turbo pumps 43 inside the downcomer region.

Placement of the hydraulic pump motors 41 outside the pressure vessel 12 has the advantage of locating electrical (and optional coolant) lines outside the pressure vessel. The external centrifugal pump motor is accessible for maintenance. Moreover, all of the components internal to the pressure vessel are located in the reactor downcomer annulus between the outer vessel wall and the reactor upper shroud. In this way, the control rod drive internals inside of the reactor upper shroud are removable without requiring removal of the pump components.

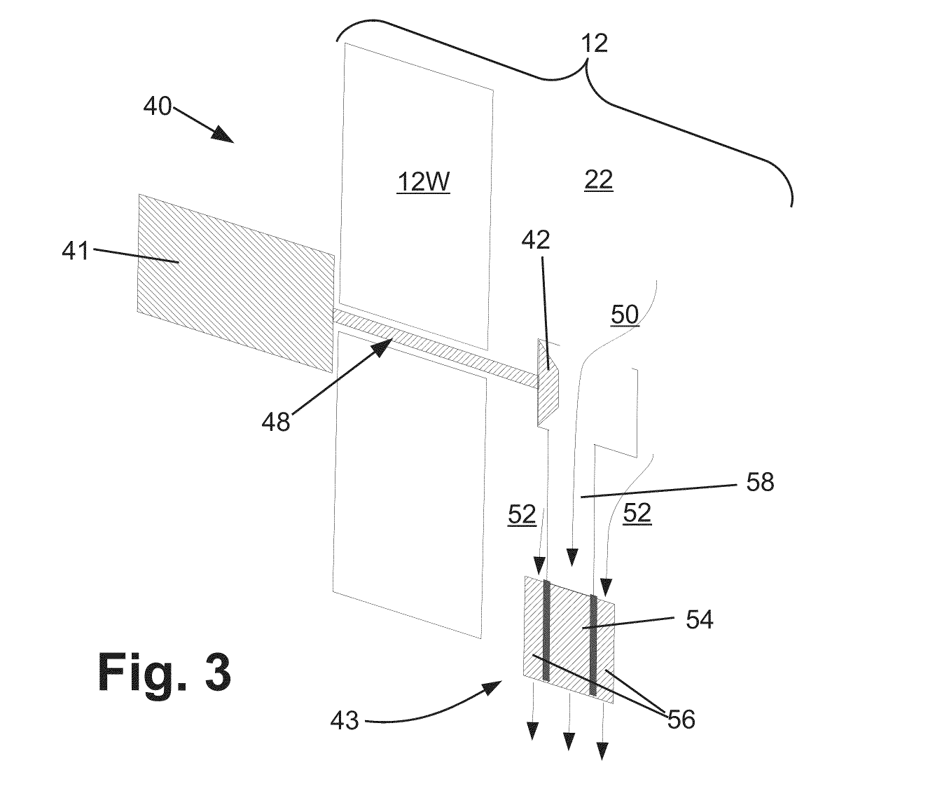

FIG. 3 diagrammatically illustrates an embodiment in which the reactor coolant pump impeller 42 is disposed in the reactor vessel 12. The electric motor 41 is disposed outside of the vessel 12 and drives the impeller 42 via a drive shaft 48 that passes through the wall 12W of the reactor vessel 12. A small portion 50 of the reactor coolant in the downcomer annulus 22 enters the intake of the impeller 42 of the hydraulic pump. The larger portion 52 of the reactor coolant enters the intake of the impeller 56 of the turbo pump 43.

The centrifugal pump impeller 42 is disposed above the turbo-pump 43 and provides a high pressure (high pump head) but low volume coolant flow to the turbo pump 43 via the outlet header 58. The high pressure/low flow enters the turbine 54 of the barrel of the turbo pump 43, causing it to rotate. As the inside of the barrel containing the turbine rotates, the outside impeller 56 also spins, which provides the low pressure but high volume flow to circulate the larger portion 52 of the reactor coolant through the reactor coolant system.

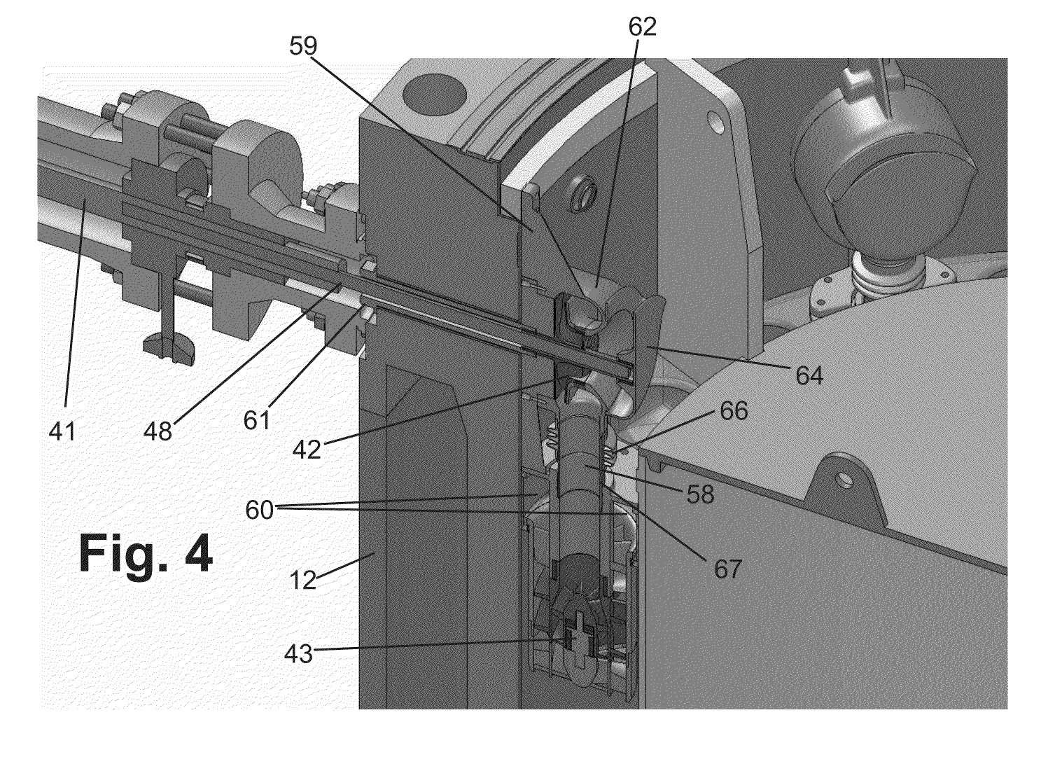

FIG. 4 is a more detailed cutaway diagram of the same view of the pump as shown in FIG. 3. There is a manifold box 60 on the suction side of the impeller of the turbo-pump 43 which accepts the portion of the primary coolant flow that does not enter the motor driven centrifugal impeller 42. In the embodiment of FIG. 4, the annular flow turbo pumps convert the excess head (pressure) of the external hydraulic pump into a larger volumetric flow. In this way, the external hydraulic pump, manifold box, and turbo pump cooperatively act as a transformer of head into flow, analogous to an electrical circuit where a transformer converts voltage to current.

The conversion of hydraulic pump head to volumetric flow enables a decoupling of the pump head of the motor-driven hydraulic pump (including the motor 41 and impeller 42) from the head requirements for pumping reactor coolant through the reactor primary coolant loop inside the pressure vessel 12. For example, the external hydraulic pump can operate at a pump head of 170 psi which is typical of a boiler circulation pump. This is many times greater than the pressure drop of the reactor primary loop. The external hydraulic pump can be operated at the best efficiency point (BEP) on the pump head curve as a function of volumetric flow rate. Likewise, the turbo-pump turbine and impeller can be optimized for the RCS pressure head and the turbo-pump portion of the total RCS flow. This decoupling of head requirements allows both pump sub-systems (i.e., the motor-driven hydraulic pump 41, 42 and the turbo pump 43) to be optimized for best efficiency.

In some integral PWR designs, the external pump flow rate need only be approximately ⅛ of the flow required by the RCS. Therefore, only a small portion (˜⅛) of the RCS flow is removed from the reactor vessel. More generally, the ratio of the fraction of primary coolant flow diverted through the external electrically driven pump to the fraction of primary coolant flow passing into the pumping inlet is typically 1:5 or lower (e.g., 1:5, or 1:6, or 1:8, or so forth), although a higher diverted fraction (e.g., 1:4) is contemplated. The smaller hydraulic pump flow in each case drives the turbo-pumps to provide the RCS total flow rate. The discharge from the turbo-pump turbines also contributes to the total RCS flow, so this is not lost, but the turbo-pumps provide most of the flow.

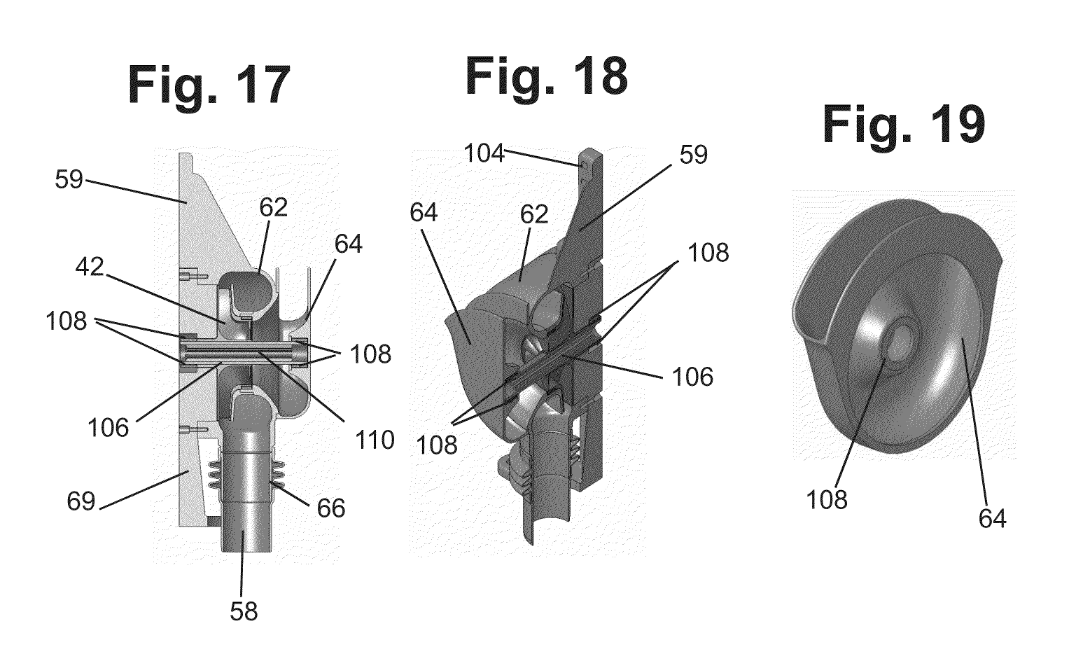

Continuing with FIG. 4, the drive shaft 48 connects the external pump motor 41 to the centrifugal impeller 42 inside the reactor vessel 12. The centrifugal impeller 42 is disposed inside a toroidal inlet/outlet header 62. Said another way, the toroidal inlet/outlet header 62 also forms the housing of a centrifugal pump that also includes the impeller 42. There is an inlet scoop 64 on the toroidal header 62 which provides support for a front bearing of a female splined collar that supports the centrifugal impeller 42 by mating with splines on the drive shaft 48 (see FIG. 17). An exit nozzle 58 connects the toroidal header 62 to an inner turbine duct of the turbo-pump via a male/female fitting 67 with O-ring seals. Also visible in FIG. 4 is a bellows 66 forming part of the exit nozzle 58 which allows the centrifugal impeller/toroidal header assembly 42, 62 to be aligned more easily with the intake to the turbine of the turbo pump by permitting a small amount of flex. The bellows 66 also makes the design less susceptible to misalignment between the header and turbo-pump. There is also a collar or bolt 61 that passes through the reactor vessel to provide support for the drive shaft 48. The toroidal inlet/outlet header 62 also has an upper bracket 59 for further support.

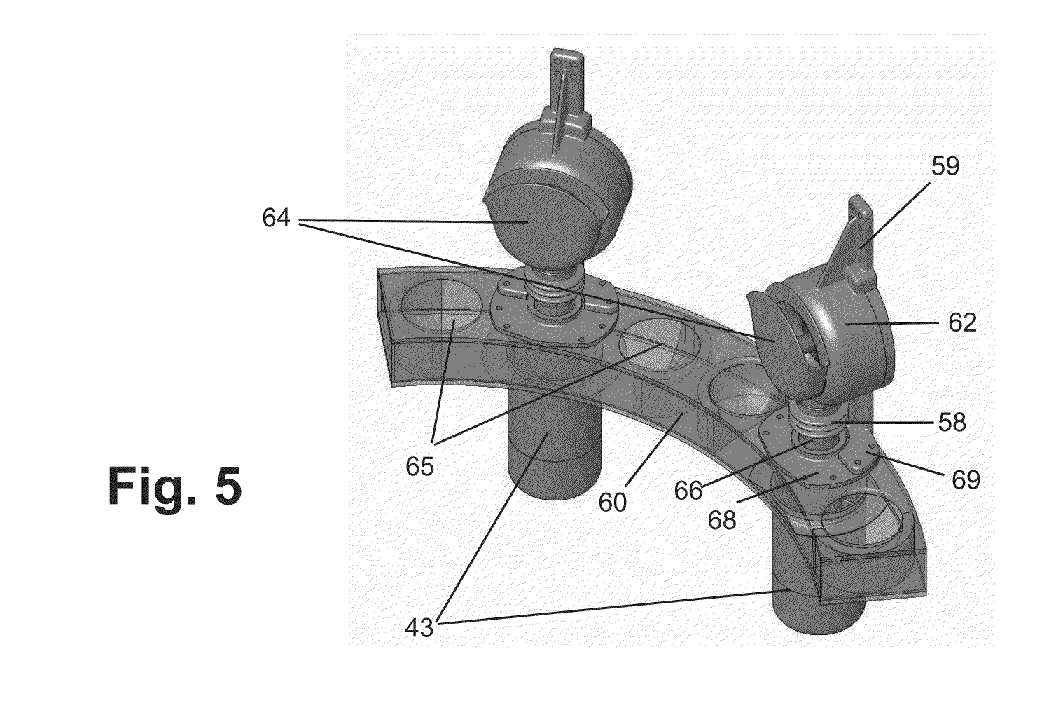

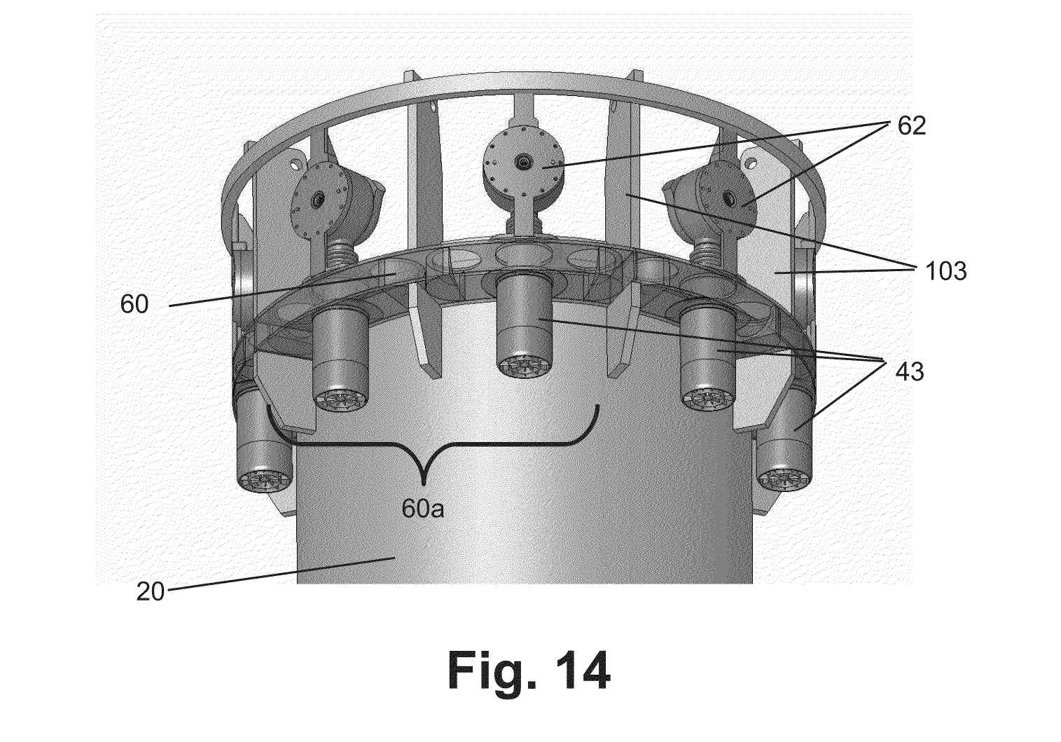

FIG. 5 depicts a single unit of a circumferential manifold box 60 with two turbo-pumps 43 and two centrifugal impeller headers 62 with inlet scoops 64. The inlet scoop 64 supplies the impeller 42 which supplies the turbine 54 of the turbo pump 43. Two inlet ports 65 per turbo-pump 43 on the top of the manifold box 60 supply the impeller 42 of the turbo pump 43 with primary coolant from the suction side of the downcomer annulus 22. Four such circumferential manifold box units (accommodating eight turbo-pumps in all) mounted on the reactor upper shroud (see FIG. 14) ring in the downcomer annulus 22 and separate the pump intakes (i.e. suction side) above the manifold from the pump discharge side below the manifold box 60. An optional flexible skirt (not shown) at the bottom of the manifold box enhances the seal to maintain the pressure difference. The turbo-pumps are supported by a flange 68 which is bolted, from the top, to the manifold 60. In this way, the turbo pumps 43 can be removed from above individually. The bolt-on flange 68 provides a seal on the top of the manifold box 60 for the turbo-pumps 43. The holes of a lower mounting bracket 69 of the rear back plate of the toroidal header 62 line up with the holes of the turbo-pump mounting flange 68. With this alignment, the same mounting bolts or studs can secure both the lower mounting bracket 69 and the outer half of the turbo pump mounting flange 68. The toroidal inlet/outlet header 62 is also supported by its upper mounting bracket 59. The exit nozzle 58 with bellows 66 connects the impeller cavity to the turbine of the turbo pump 43.

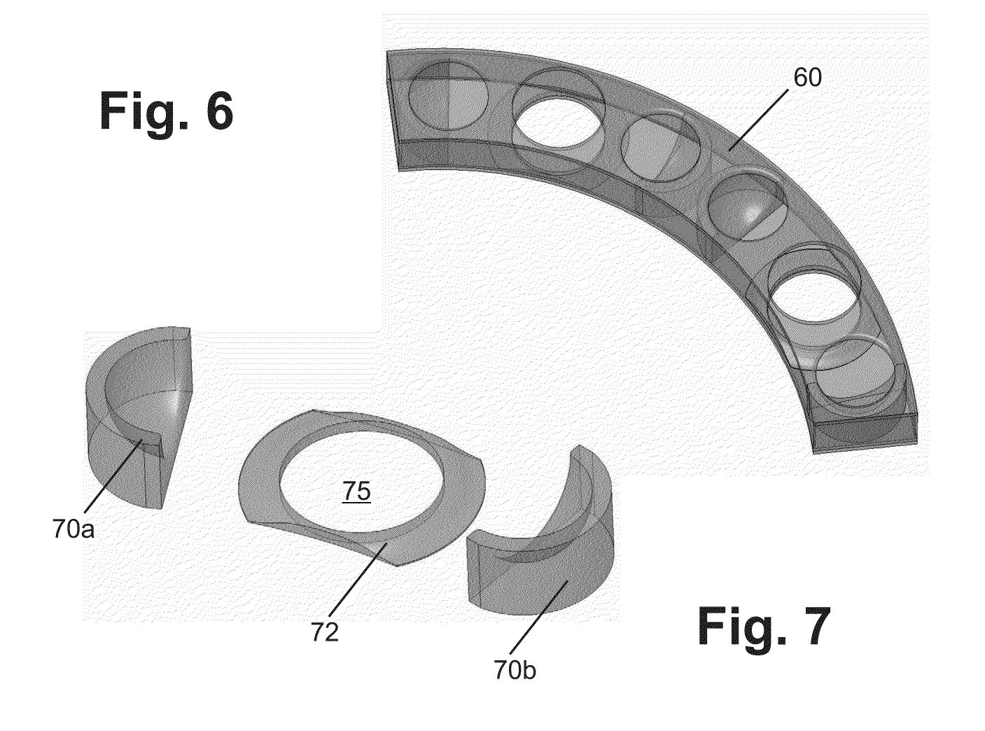

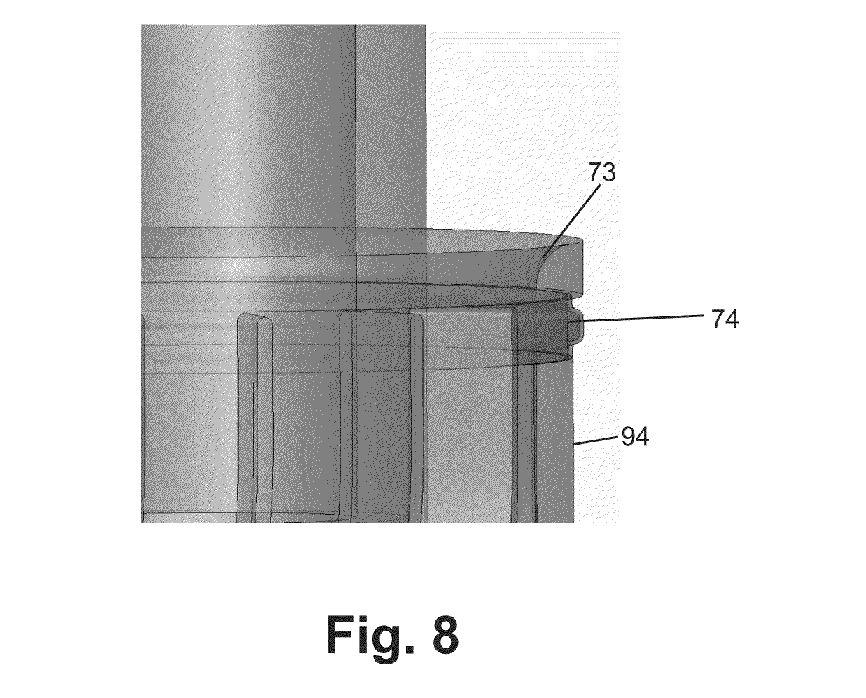

Another view of the circumferential manifold box 60 is shown in FIG. 6, here with the turbo-pumps, toroidal header, and associated flanges removed. A pair of flow distribution headers is sandwiched between the top and bottom plates of the manifold box. FIG. 7 shows two symmetric spherical concave flow diverters 70a, 70b which define a single distribution header. There is one distribution header per annular flow turbo-pump. The flow diverters direct the downward primary coolant flow horizontally into the annular flow turbo-pump. An entrance ramp 72 is also provided to help clear the upper edge of the turbo-pump inlet because the upper edge 73 of the turbo-pump protrudes slightly into the manifold box space to accommodate a seal ring 74 on the turbo-pump housing, shown in FIG. 8, which compresses against the hole 75 in the lower manifold box plate.

Although the manifold box unit 60 is shown as a quarter of a circle with room for two pumps (so that four such manifold box units form a complete circumference), other designs are contemplated, such as one pump per manifold box with eight manifold boxes ringing the vessel or a semicircular manifold box. It also contemplated that the top plate of the manifold could be eliminated and only a baffle plate used as a divider between the high pressure discharge side of the pumps and the lower pressure suction.

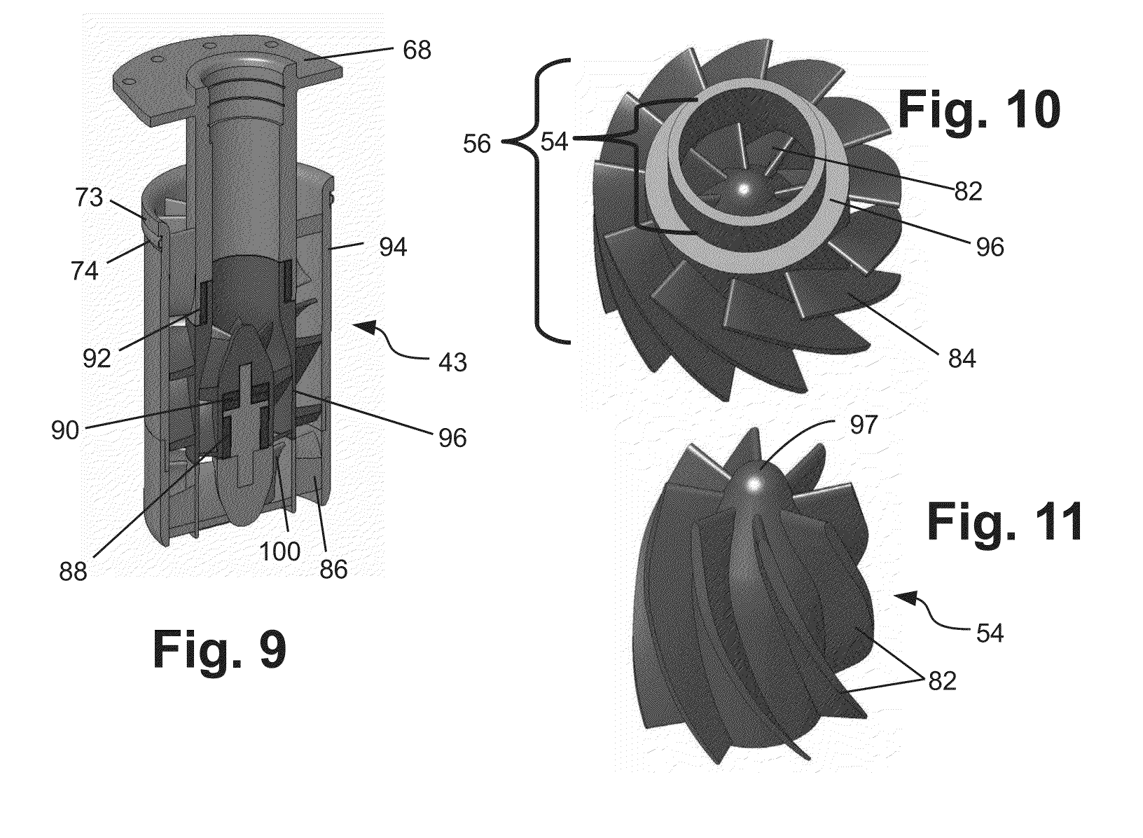

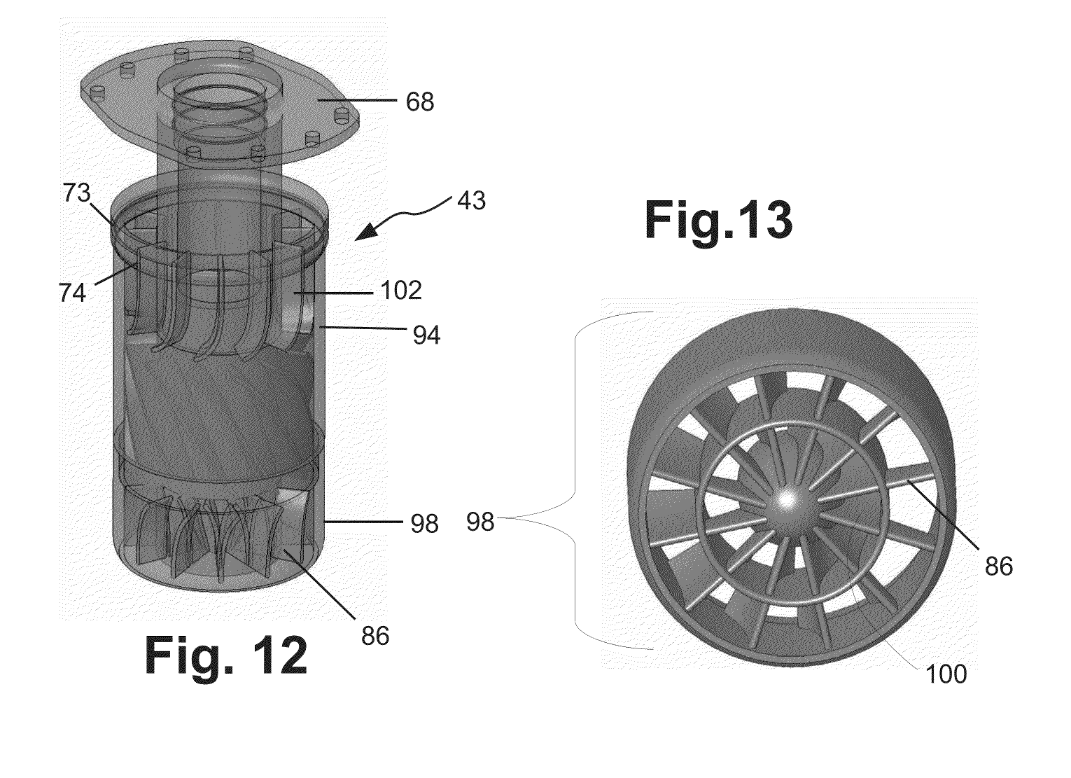

FIG. 9 depicts the annular flow turbo-pump 43 with support flange 68 in a perspective side-sectional view. FIG. 10 depicts the unitary turbine/impeller barrel 96 with outer impeller blades 84 and inner turbine blades 82. FIG. 11 shows the turbine blades 82 on the inside of the cylindrical rotating barrel 96 with the impeller blades and barrel omitted. The turbine blades 82 are disposed on the outside of a central hub 97 of the unitary assembly 96 and form the turbine 54 of the turbo-pump 43. The annular drive turbine 54 uses axial flow over cambered turbine blades 82 to create lift and rotation. There are fixed vanes 100 (for the turbine), 86 (for the impeller) immediately downstream of the turbine and impeller blades' rotating barrel (shown in FIG. 9, see also FIGS. 12 and 13). Support and constraint of the rotating unitary element 96 is provided by radial bearings 88 and axial thrust bearings 90 located on the lower turbo-pump assembly and inside the turbine hub. Radial bearings 92 are also located between the rotating barrel and the upper turbo-pump assembly. The main thrust bearings 90 are located at the top of the bearing shaft mounted on the lower exit hub assembly. Reverse thrust bearings are not shown in FIG. 9 since reverse flow is uncommon except during accident conditions (blowdown). The two sets of radial bearings 88, 92 can accommodate a limited amount of reverse thrust if they have a grooved bearing race. A reverse thrust bearing can also be included underneath the upper disk of the bearing shaft if needed.

The impeller blades 84 (FIG. 10) are disposed on the outside of the unitary rotating barrel 96 and are located within the annulus defined between the rotating barrel 96 and the upper housing wall 94 (FIG. 9). The impeller blades 84 circulate the primary coolant water from the manifold box 60 (see FIGS. 5-7). The impeller blades 84 are curved with a shallow leading edge blade angle transitioning to an increased and constant blade angle and form the impeller 56 of the turbo-pump 43.

The annular flow turbo-pump 43 is shown in FIG. 12 in perspective view similar to that of FIG. 9, but without the sectioning. Its outer housing 94 is shown in phantom to reveal the inner vanes. The housing 94 is sized to allow insertion through the manifold box mounting hole. The upper flange 68 is bolted to the top of the manifold box 60 (see FIGS. 5-8) and the turbo-pump is also supported by the lip of the opening 75 in the lower manifold box plate and sealed against the lip by the gasket or O-ring 74. The components of the turbo-pump external housing are shown in FIG. 12 and include the upper housing 94, the mounting flange 68, and the lower housing 98 (see also FIG. 13) with fixed turbine outlet vanes 100 and impeller outlet vanes 86. The impeller outlet vanes 86 are curved in the direction of rotating flow on the upstream side then transition to a vertical orientation for axial outflow. The fixed vanes 100 are curved toward the direction of rotating flow then transition to a vertical vane angle for axial outflow. There are also fixed vanes 102 on the upstream side of the impeller rotating blades. The vanes 102 are curved with a vertical orientation at the inlet from the manifold box then angled in the direction of rotating flow of the impeller blades 84.

The circumferential structure formed by arrangement of four manifold box units 60 is shown in FIG. 14, which shows a perspective view of a portion of the reactor in the vicinity of the circumferential manifold with the pressure vessel omitted. In the illustrative arrangement, the manifold boxes 60 are mounted sandwiched between gussets 103 of the reactor upper shroud. In this way, the manifold box shroud assembly can be inserted without damage to the manifold boxes 60. The tapered ends of the gussets guide the assembly into the reactor vessel. One manifold box is labeled 60, spanning two turbo pump assemblies, its width indicated by bracket 60a. The turbo-pumps 43 and accompanying toroidal headers 62 housing the centrifugal impeller 42 (not visible in FIG. 14, but see FIG. 4) are removable from the top individually or the entire assembly (shroud and manifold boxes) can be removed. The entire assembly would usually only be removed for inspection of the reactor vessel at intervals longer than the refueling cycle. While the arrangement shown in FIG. 14 includes intervening gussets 103, it is also contemplated to omit or relocate the gussets, and to have the manifold box units 60 abut around the circumference. In embodiments in which the gussets 103 are omitted or relocated, it is also contemplated to replace the sectioned manifold boxes 60 with a single-piece annular manifold box.

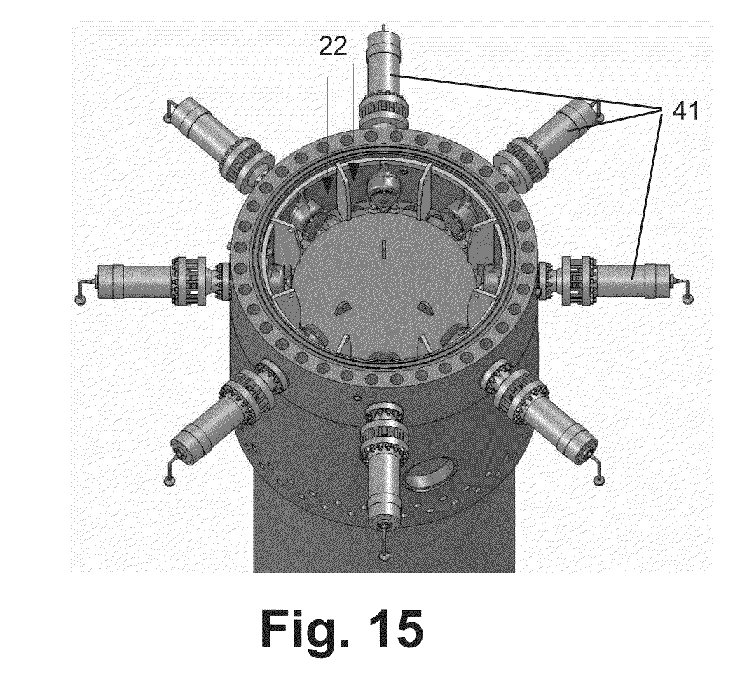

FIG. 15 shows eight electrical pump motors (three of which are labeled 41) circumferentially positioned ringing the reactor vessel. The eight external motors drive eight internal centrifugal pump impellers via drive shafts (see FIG. 4). Each centrifugal pump drives one annular flow turbo-pump to circulate reactor coolant in the downcomer 22.

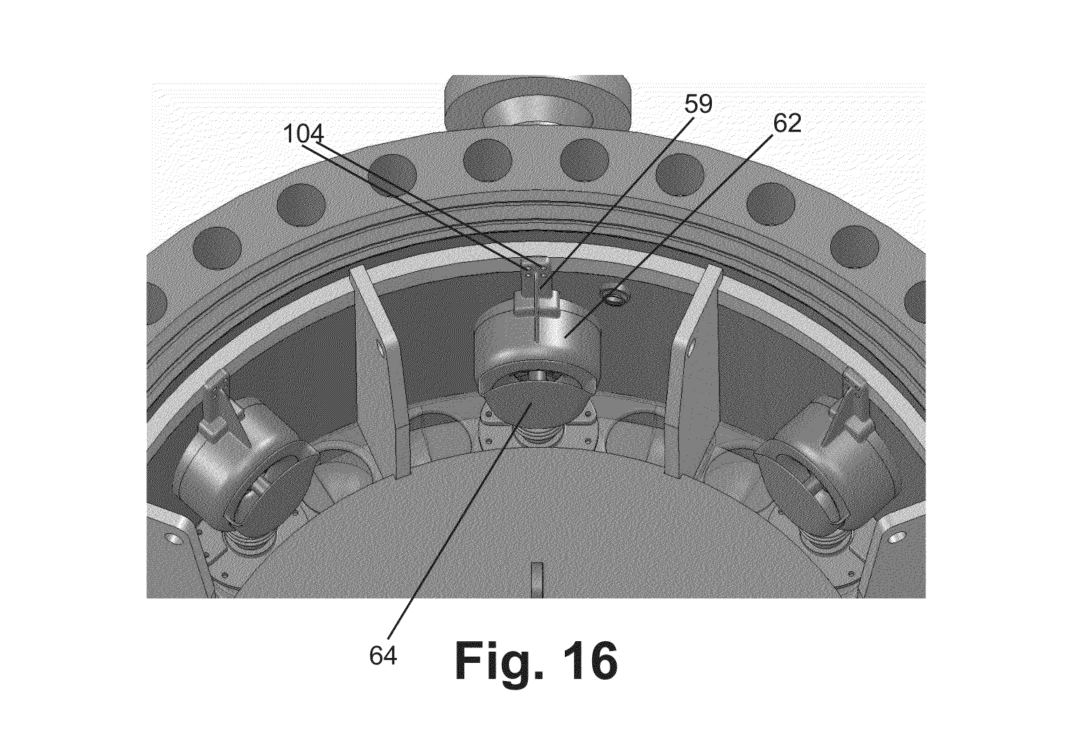

FIG. 16 is a detail view of the inlet scoop 64 and front mounting bracket 59 of the impeller housing 62. Also visible are mounting holes 104 for bolts.

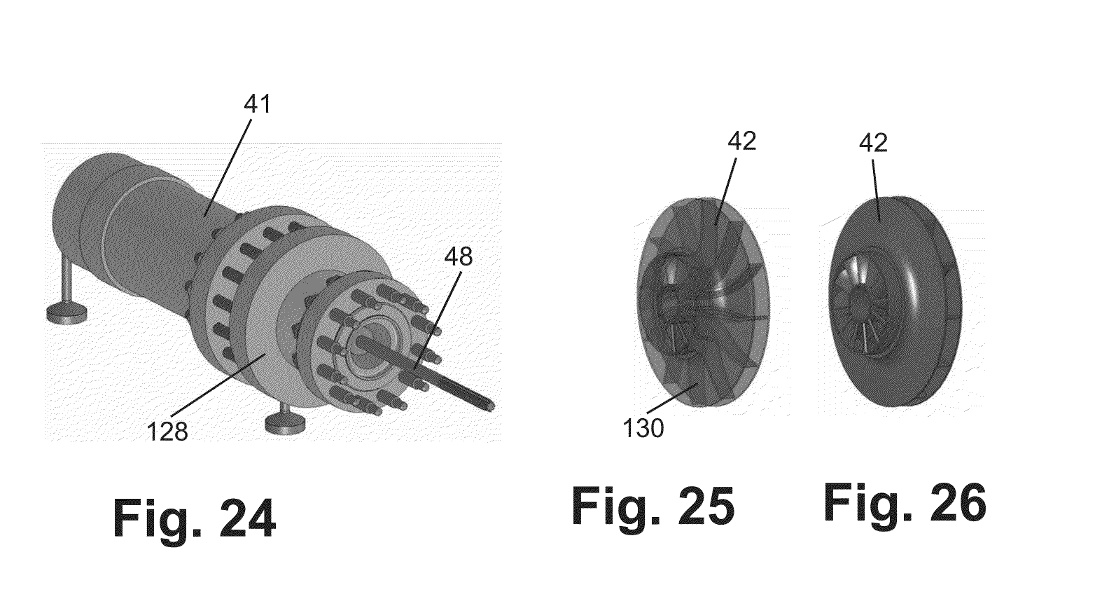

FIGS. 17 and 18 are side profile sections of the centrifugal pump including the toroidal header 62 with inlet scoop 64 (see FIG. 19), female splined collar 106, centrifugal impeller 42, upper and lower mounting flanges 59, 69, and exit nozzle 58 with bellows 66. The exit nozzle 58 also has an inner bellows sleeve (visible inside bellows 66) to maintain a constant inner pipe diameter. The female splined collar 106 has bearings 108 separate from the pump motor bearings to support the loads on the impeller 42. The splined drive shaft 48 (see FIG. 4 or 24) turns inside a hollow locking collar which is configured as a bolt (FIG. 23) and mates with the splines 110 of the collar 106. The toroidal header 62 forms a casing enclosing the impeller 42 to define a centrifugal pumping system. In some embodiments the toroidal header 62 is shaped to define a circular or volute chamber or casing. A volute configuration is more complex, but typically can be designed to provide higher head versus a similar circular chamber.

FIG. 19 is a detail of the inlet scoop 64 showing the front bearing 108 that mates with the female splined collar 106. The inlet scoop 64 channels primary coolant toward the impeller 42 (see, e.g. FIG. 17) and also serves to contain the front bearing 108 of the female splined collar 106.

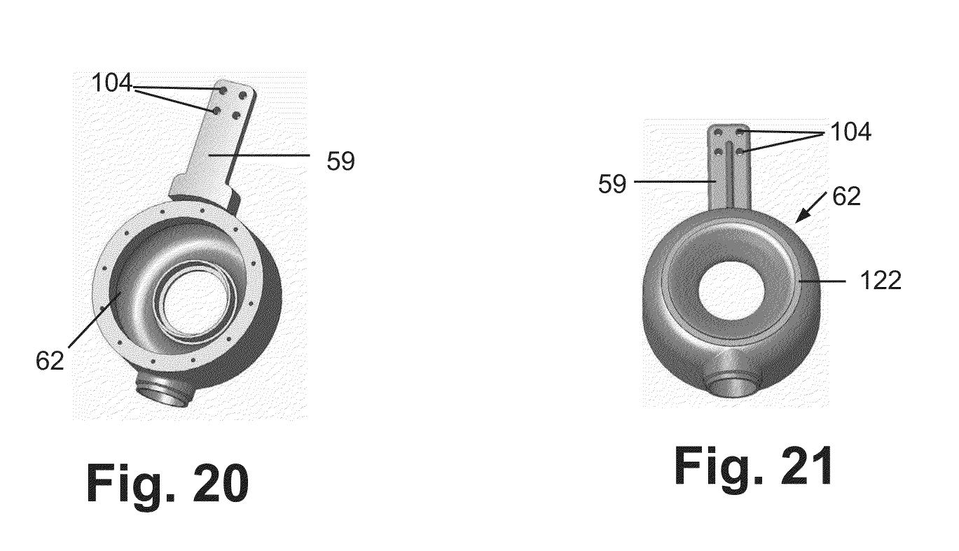

Two isolation perspective views of the centrifugal pump inlet/outlet torus header 62 (or, in an alternative view, the centrifugal pump housing 62) are shown in FIGS. 20 and 21. As seen in FIG. 21, the front 122 of the housing 62 is milled to mate with the inlet scoop 64. Also shown in FIGS. 20 and 21 are four bolt holes 104 on the top bracket for attachment to the upper shroud support ring.

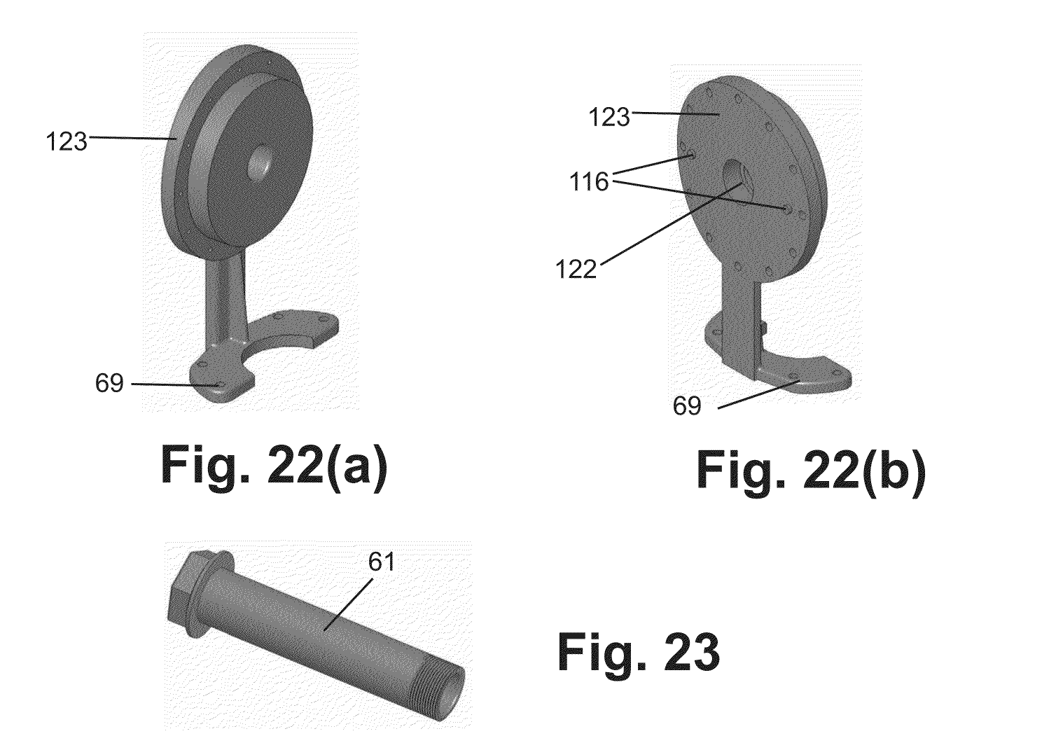

Shown in FIGS. 22a and 22b are two isolation perspective views of a back plate 123 of the toroidal header 62 which includes the lower mounting bracket 69 for attachment to the flange (see FIG. 5) of the annular flow turbo pump on top of the manifold box. FIG. 23 shows an isolation perspective view of the hollow locking bolt 61 through which the hydraulic pump impeller shaft passes (see also FIG. 4). The hollow locking bolt 61 passes through the reactor vessel and screws into the back plate 123 of the centrifugal pump header/housing 62. The head of the bolt is enclosed by an opening 122 in the back plate 123. The backing plate has alignment pins 116.

FIG. 24 shows the centrifugal pump external pump motor 41 (see also FIG. 15) with the splined drive shaft 48 which passes through the hollow locking bolt 61 of FIGS. 4 and 23 and through the splined collar 106. This design is similar to a vertical boiler circulation pump converted to a horizontal layout. It uses a thermal barrier 128 that clamps between the front head and the motor main body. The bolts and thermal barrier are made of low heat conductance materials. The external hydraulic motor head encloses the drive shaft and mounts to a flat milled surface on the reactor vessel flange forging. There is no external piping between the motor and the reactor vessel. Not having connecting pipes between the vessel and motor head minimizes the possibility of a small break loss-of-coolant accident (LOCA).

FIG. 25 is an isolation perspective view of the impeller 42 with the front surface shown in phantom to reveal the impeller blades 130. FIG. 26 is an isolation perspective view of the impeller 42 showing its front surface.

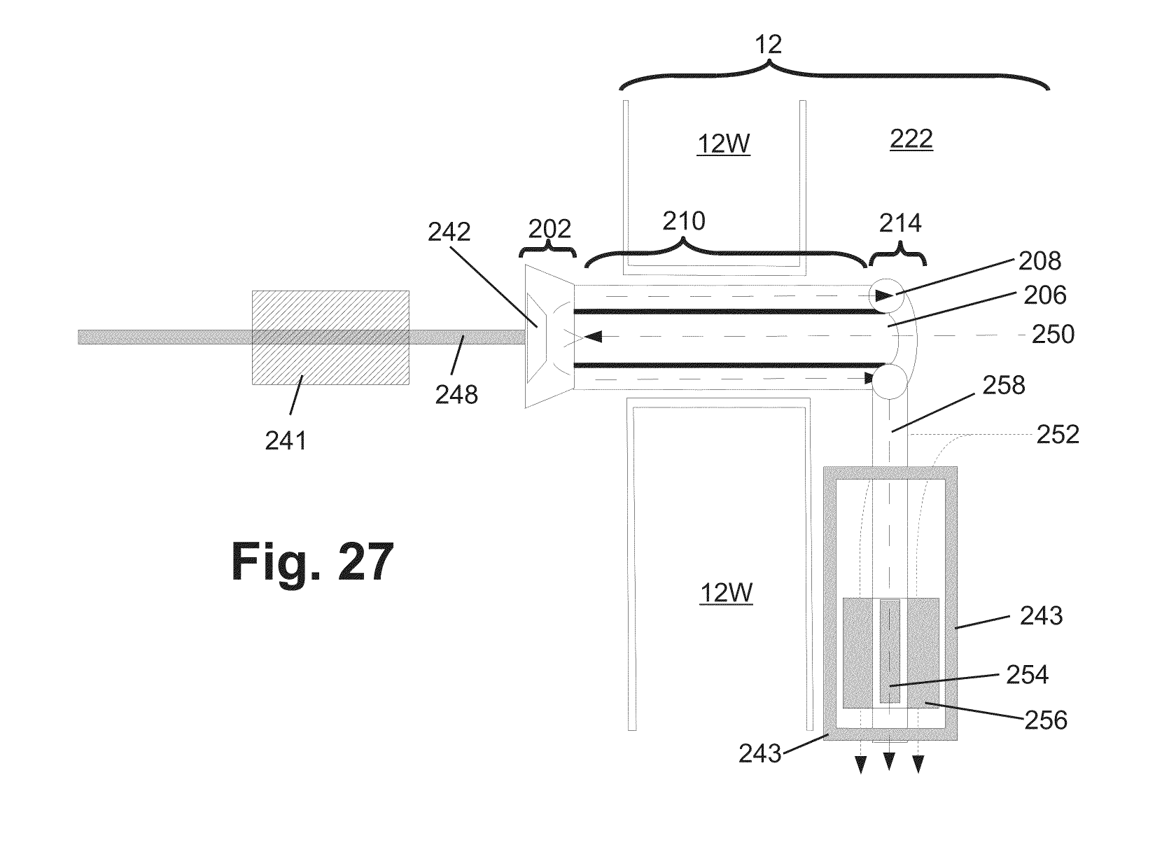

With reference to FIG. 27, an embodiment is described in which the centrifugal pump impeller is external to the reactor vessel and uses a coaxial coupler to an internal torus header which supplies the annular flow turbo pump. As with the previous embodiment, the use of turbo pumps eliminates the problem of having high voltage electrical lines inside the reactor vessel, since in each case the pump motor is external to the vessel. Several features are unchanged in this embodiment. The manifold box with flow distribution headers is suitably identical to the configuration shown in FIG. 5-7 (though the intakes for the hydraulic pump are different). The annular flow turbo-pumps are also suitably identical. The centrifugal impeller is also suitably the same as FIGS. 25 and 26. The front housing of the hydraulic pump is similar to the front housing disclosed above, but no milling is necessary to accommodate the front scoop as there is no front scoop. The machining inside is simpler because there is no need for the bearings and attachment of the centrifugal impeller. The drive shaft does not extend through the wall of the pressure vessel.

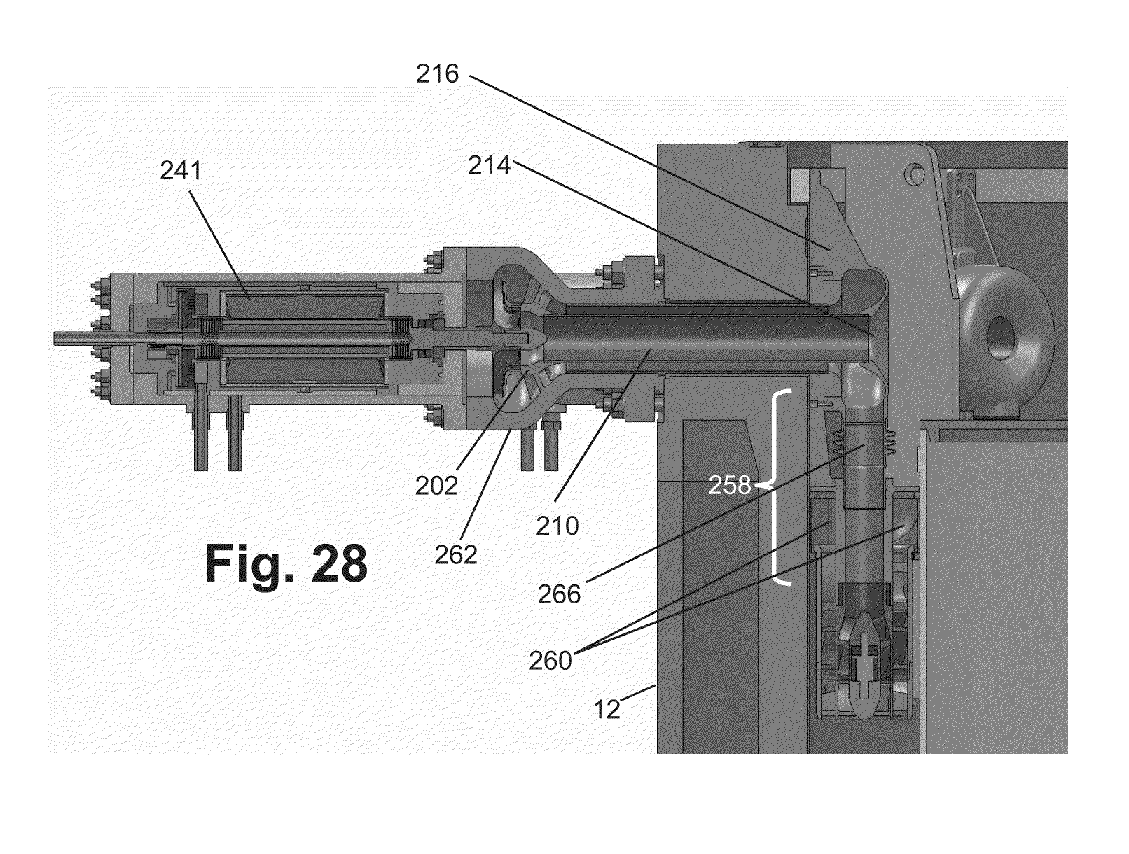

FIG. 27 is a simplified diagram of the flow within the embodiment with the impeller external to the reactor. The electric motor 241 is, as before, disposed outside of the vessel 12 and drives an impeller 242 via a drive shaft 248, although in this embodiment the drive shaft is shorter and does not pass through the pressure vessel wall 12W. The impeller 242 is located outside of the reactor vessel 12 in an impeller cavity 202 inside the head of the centrifugal pump. The impeller cavity is connected to a toroidal inlet/outlet header 214 disposed inside the reactor 12 by a coaxial coupler 210 that passes through the wall 12W of the pressure vessel 12. The inlet/outlet header 214 has a center inlet 206 feeding into the impeller cavity 202 and an annular outlet 208 which connects the discharge of the centrifugal pump to the turbo pump turbine 254 via an outlet header 258. A small portion 250 of the reactor coolant in the downcomer annulus 222 enters the center inlet 206 of the inlet/outlet header 214. The larger portion 252 of the reactor coolant enters the intake of the impeller 256 of the turbo pump 243 via the manifold box 260 (shown in FIG. 28).

As in the prior embodiment, the centrifugal pump impeller 242 provides a high pressure (high pump head) but low volume coolant flow to the inside turbine 254 of the barrel of the turbo pump 243, causing it to rotate which in turn rotates the outside impeller 256, which provides the low pressure but high volume flow to circulate the larger portion 252 of the reactor coolant through the reactor coolant system. The flow through the hydraulic pump flows from the center inlet 206 through the inner pipe of the coaxial coupler 210 to the inlet of the impeller cavity 202 where it is pumped by the impeller 242 to the annular pipe of the coaxial coupler 210 to the annular outlet 208 of the inlet/outlet header 214. From the outlet of inlet/outlet header 214, the fluid travels through the outlet header 258 to the turbine 254 of the turbo-pump, where it spins the turbine, causing the impeller 256 of the turbo-pump to spin, as in the previous embodiment. The turbo-pump 243 is suitably identical to that of FIG. 9. As previously stated, other flow amplification devices are contemplated, such as jet-pumps.

FIG. 28 is a more detailed cutaway diagram of the same view of the pump as shown in FIG. 27. The inlet/outlet header 214 connects to the inner turbine of the turbo-pump via an outlet header 258 including a male/female fitting with O-ring seals. As in the prior embodiment, the outlet pipe 258 has a bellows 266 with an inner bellows sleeve to maintain a constant inner pipe diameter. The coaxial coupler 210 requires only one circular hole in the reactor vessel for both inlet and outlet, minimizing the number of vessel penetrations.

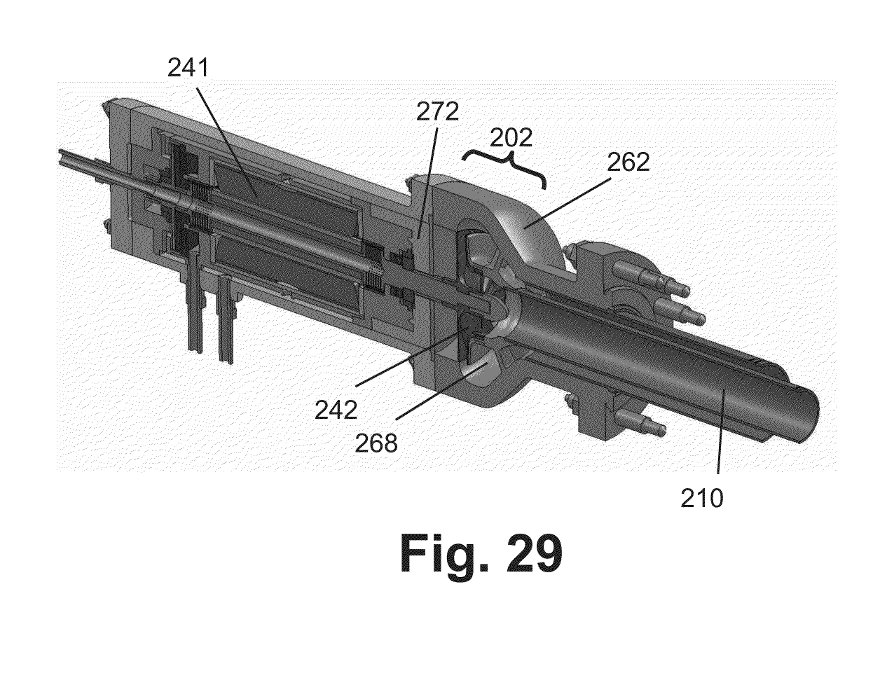

A side-sectional perspective view of the coaxial inlet/outlet header 210 and the centrifugal hydraulic pump is shown in FIG. 29. An external hydraulic pump head 262 encloses the end of the coaxial line 210 located outside of the pressure vessel, so that external piping is not present. Not having connecting pipes between the vessel and pump head minimizes the possibility of a small break loss-of-coolant accident (LOCA). The pump head 262 comprises a vessel flange that defines the impeller cavity 202 that contains the centrifugal impeller 242. The opposite end of the pump head 262 bolts to the pump motor assembly 241.

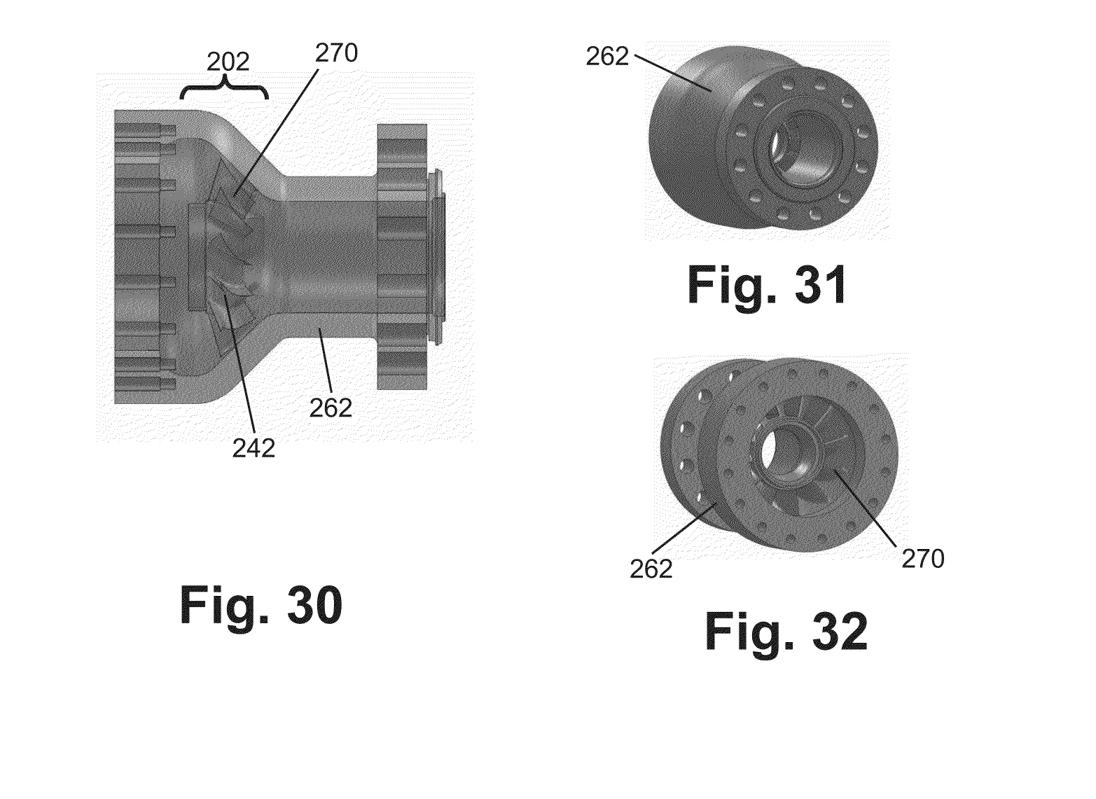

FIG. 30 shows a side sectional view of the pump head 262 and of the impeller 242 disposed in the pump cavity 202. Fixed vanes 270 are also disposed inside the centrifugal impeller head 262. The coaxial pipe 210 and toroidal header 214 provide a compact and efficient flow path. FIG. 31 shows the front of the pump head 262 which attaches to the pressure vessel 12. The turning vanes 270 are shown in the rear view of the pump head 262 In FIG. 32.

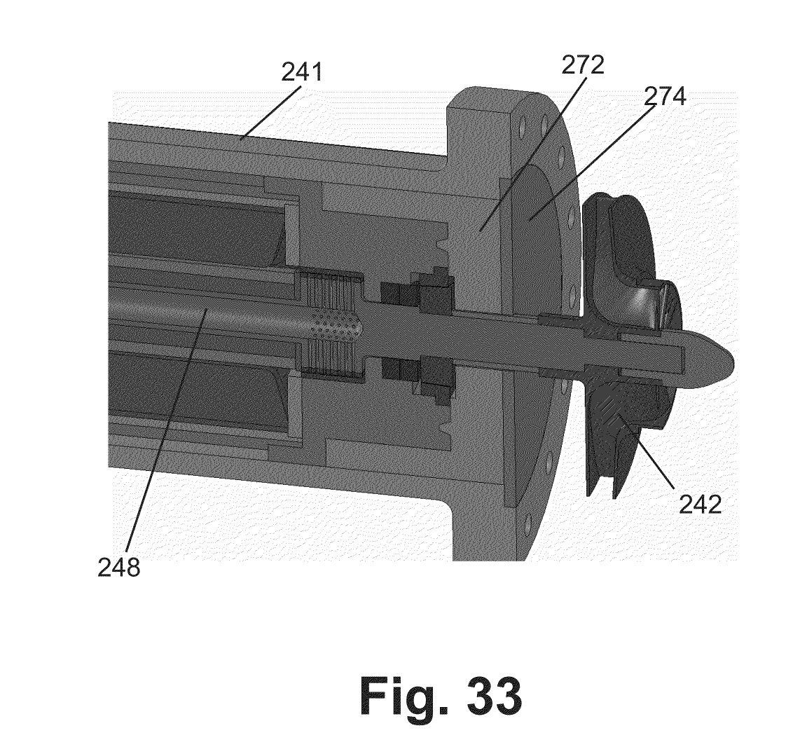

With reference to FIG. 33, which shows in side-sectional perspective view the end of the pump motor 241 that connects with the pump head 262, there is a thermal shield 272 behind a cover plate 274 that clamps down between the motor flange and the pump head 262. An advantage of the external centrifugal pump is that the motor assembly can be removed from the centrifugal impeller head 262 for maintenance. The entire motor assembly can be unbolted and the centrifugal impeller slides out of the head 262.

The external centrifugal pump motor 241 preferably exhibits robust and long service life. Toward this end, hydraulic radial and thrust bearings are optionally provided as set forth herein.

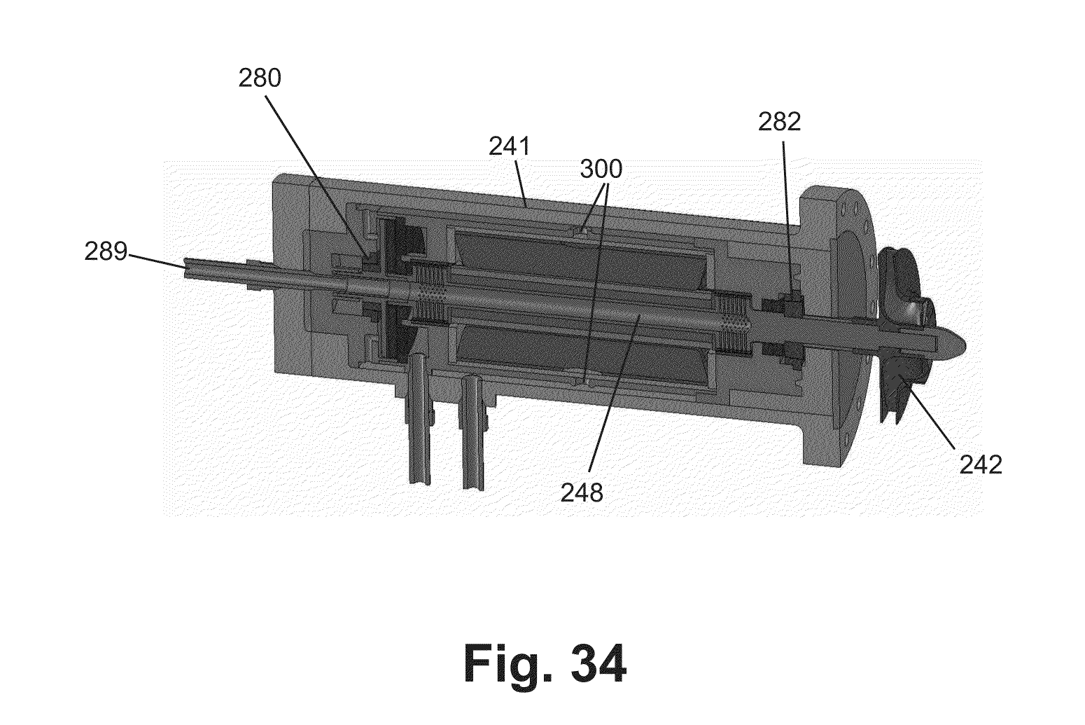

FIG. 34 shows a side-sectional perspective view of the pump motor 241 with the impeller 242 attached. Pump motor bearings shown in FIG. 34 include mechanical bearings 280, 282 for short time duration startup and shutdown. During normal operation (i.e., when the drive shaft is rotating at an operating speed), the mechanical bearings (radial and axial thrust) are disengaged and the loads are transferred to hydraulic radial and main thrust bearings. The mechanical radial bearings are suitably high temperature bushings such as the Graphalloy® (trademark of Graphite Metallizing Corporation) graphite/metal alloy bearings.

The hydraulic bearing engagement/disengagement uses the forward pulling thrust (tractor thrust) of the centrifugal impeller 242. The drive shaft 248 slides axially with the tractor thrust to engage the main hydraulic thrust bearing. The displacement of the drive shaft 248 also disengages the mechanical radial bearings 280, 282 by using a tapered (angled) bearing surface. A small axial displacement of approximately ⅛″ will open the interface of the mechanical radial bearing so that they are not loaded during normal operation. This gives long service life of the radial bearing since the rotational friction force is unloaded except during startup and shutdown. The design uses a hollow drive shaft 248 for the motor with a pump coolant feed 289 at the back end of the shaft.

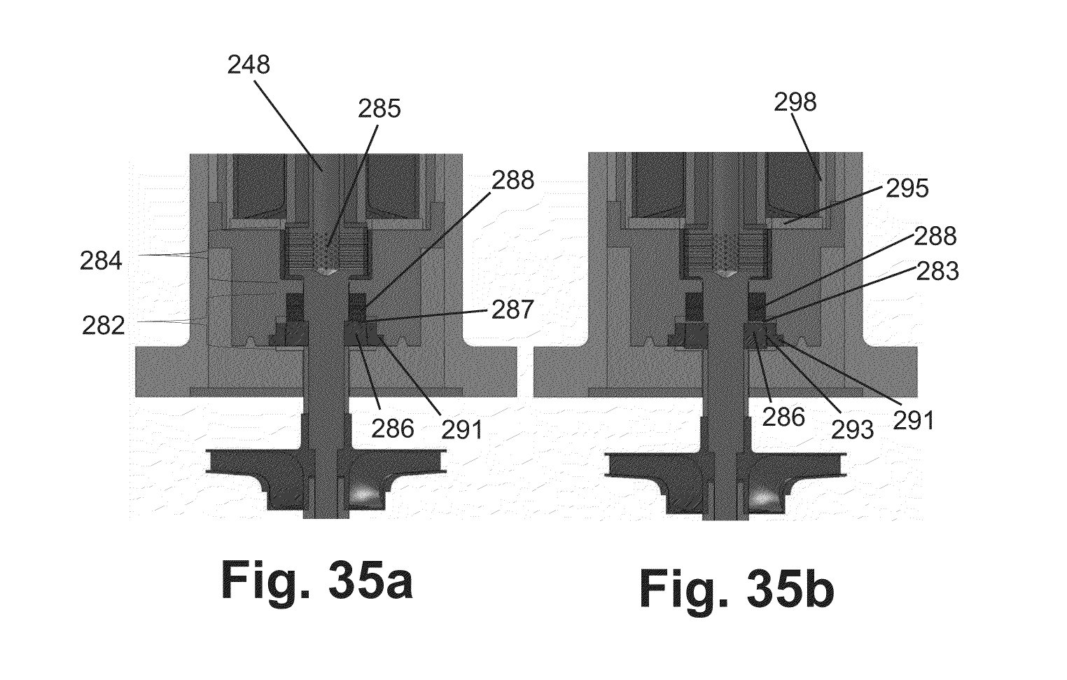

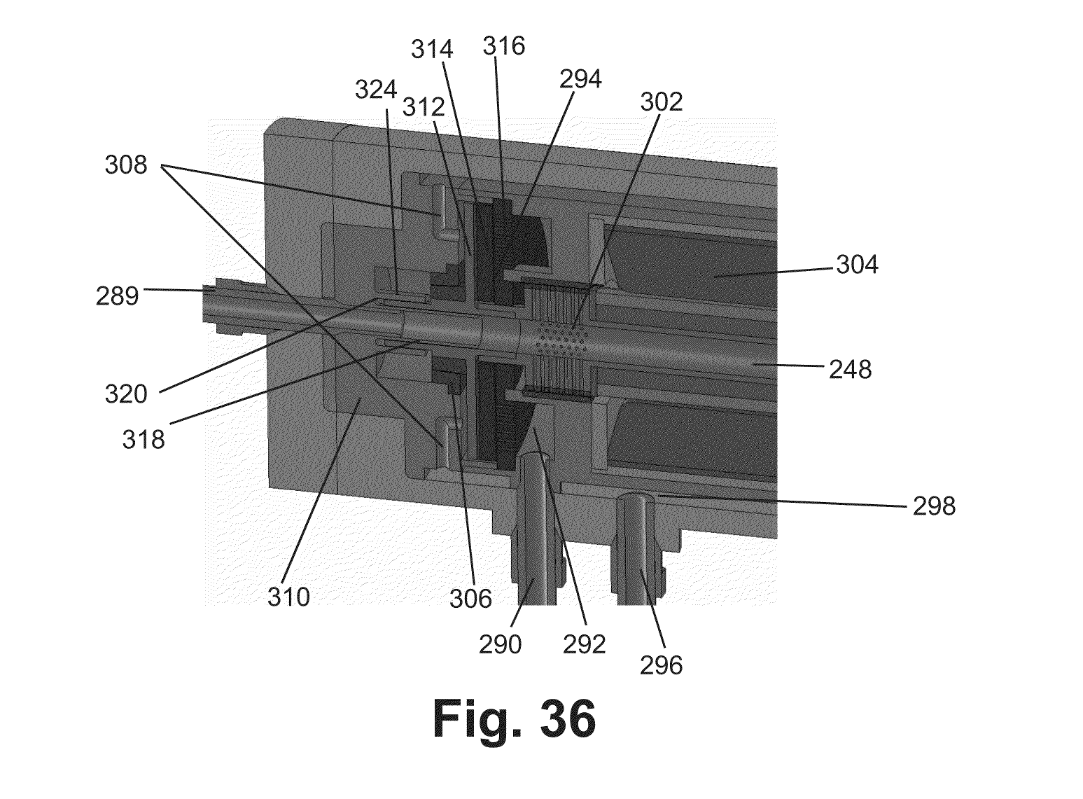

FIGS. 35(a) and 35(b) show the front bearing layout with hydraulic radial bearing 284 with startup mechanical thrust and radial bearings. FIG. 35(a) shows the configuration during startup, while FIG. 35(b) shows the configuration during normal operation. The high pressure of the coolant feed forces coolant through radial holes 285 in the drive shaft 248 to create a liquid film layer between the main shaft and a graphite/metal bearing surface at interface 287. This thin film lubricates the front hydraulic radial bearing 284 and supports the shaft 248 during normal operation. The coolant feed pressure is augmented by the centrifugal forces of the coolant spinning out of the radial bearing holes 285 of the front radial hydraulic bearing 284. The coolant flows through a channel 295 to a plenum 298 (labeled in FIGS. 35b and 36) which cools the stator windings. The coolant then exits via flow nozzles 300 (shown FIG. 34).

The positions of the main shaft and front bearing assembly are shown during startup in FIG. 35(a) and normal operation in FIG. 35(b). At startup, the inner bushing 286 of the mechanical radial bearing 282 contacts the startup thrust bearing 288. This limits the reverse travel of the main shaft during startup and shutdown. During normal operation, the main shaft is pulled forward by the impeller, creating a gap 283 (FIG. 35b) between the inner bushing 286 and the startup thrust bearing 288. Because radial bearing surfaces have a slight incline, a gap 293 is also created between the inner bushing 286 and outer bushing 291 of the mechanical radial bearing 286. These gaps 283, 293 disengage the mechanical bearings 286, 288. Once the mechanical bearings are disengaged, the hydraulic radial bearing 284 is carrying the load.

An enlarged view of the rear bearing assembly is shown in FIG. 36. There are two coolant inlets: inlet 289 at the rear shaft axis and inlet 290 on the bottom which feeds an internal annular plenum 292 for the main hydraulic thrust bearing. There is one coolant outlet 296 on the outer pump vessel wall that takes up coolant from the annular space 298 between the outer pump vessel and the pump inner casing. The coolant exits from the motor through two nozzles 300 (shown in FIG. 34) on the pump inner casing. As discussed above, the motor passes the discharge from the radial hydraulic bearings 284, 302 to the annular space 298 to cool the motor stator windings 304 before the coolant exits through the pump casing nozzles 300.

The rear hydraulic radial bearing 302 and rear mechanical radial bearing 306 operate on the same principle as the front hydraulic radial bearing 284 and front mechanical bearing 282, respectively, discussed previously. The rear mechanical radial bearing 306 is also inclined and disengages the friction surface during normal operation in the same manner as the front bearing. However, the rear radial mechanical bearing 306 does not have a thrust bearing like the front one. Only one startup thrust bearing is needed, and it is in the front of the motor. Like the front hydraulic radial bearing, the coolant that forms the liquid film exits into a plenum 298 surrounding and cooling the motor stator assembly.

Also shown in FIG. 36 is a configuration that minimizes leakage from the rear axial coolant inlet to the back side of the main thrust bearing. The pressure on the back side of the main thrust bearing is kept low via the two exit channels 308 milled into the motor back plate 310. The channels provide a path from the back of the back side of the main thrust bearing rear plate 312 to the coolant outlet annulus 298.

The pressure on the back side of the main hydraulic thrust bearing rear plate 312 and clutch 314 must be kept near the coolant outlet pressure for the bearing to function properly. Leakage from the axial coolant inlet 289 used for the main shaft radial bearings 302, 284 should be kept low to avoid parasitic losses of coolant and also to prevent pressurization of the back side of the main thrust bearing rear plate 312. This is accomplished by having a serpentine or other tortuous path for coolant leakage from the axial coolant inlet 289 to the milled exit channels 308. In the illustrative serpentine path, the coolant first flows through a gap between the inner main shaft 248 and rear inner sleeve 318, then turn 180 degrees at a channel 320 and go through a gap between the outer main shaft and the main shaft collar 324 and finally through the bearing gap of the radial mechanical bearing 306 to the back side of the main thrust bearing clutch rear plate 312.

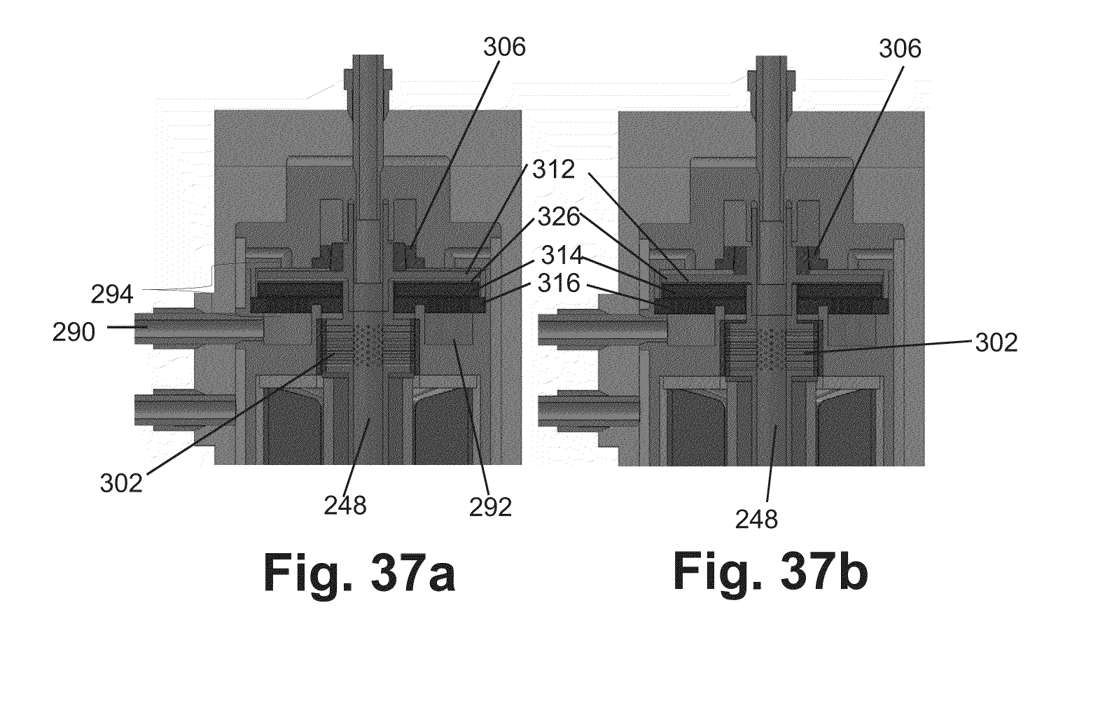

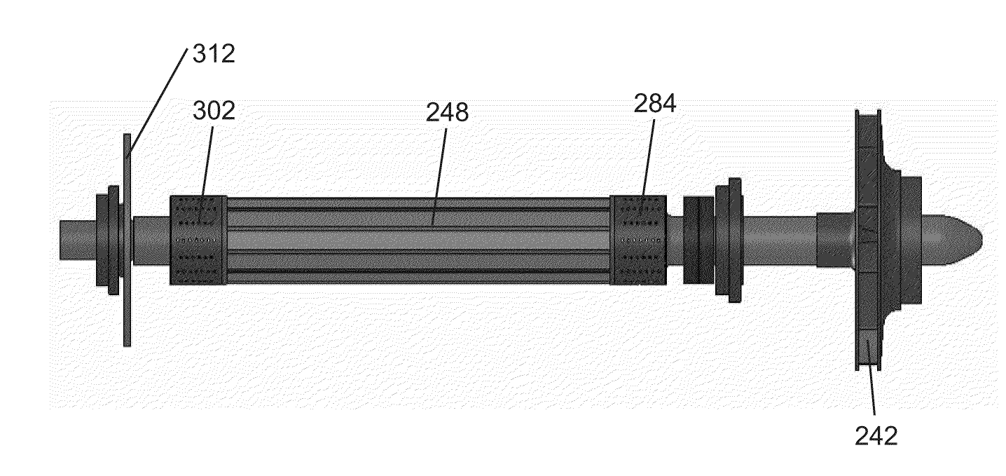

The positions of the main thrust bearing and rear radial bearings are shown in FIGS. 37(a) and 37(b) for startup/shutdown and normal operation. The forward thrust engages the rear plate 312 on the main shaft with the rear hydraulic bearing plate 314. Rear plate has a clutch pad 326. The forward thrust also disengages the rear radial mechanical bearing 306 for normal operation. The front plate 316 of the main thrust bearing 294 has holes to receive coolant from the annular space 292 connected to the bottom coolant inlet nozzle 290. The coolant under pressure forms a liquid film layer between the front plate 316 and rear plate 314 of the main hydraulic thrust bearing. Under normal operation, the entire main shaft assembly 248 is supported entirely on liquid films by the hydraulic radial bearings 302, 284 and main thrust bearing 294. This should give very long bearing life since there is no metal on metal friction and the mechanical bearings, which do have friction surfaces, are disengaged.

FIG. 38 shows the drive shaft 248 removed to show the front and rear hydraulic radial bearings 302, 284 with holes for coolant flow, as well as the clutch rear plate 312 for the hydraulic thrust bearing.

The illustrative bearing configuration is an illustrative example. It will be appreciated that other configurations may be employed. In general, the configuration relies upon the rotation of the centrifugal impeller providing a forward pulling thrust (tractor thrust) on the drive shaft 248 that introduces gaps that disengage the mechanical radial and thrust bearings, operating in conjunction with hydraulic radial and thrust bearings defined by interfaces lubricated by primary coolant water. In the illustrative embodiment, this primary coolant water also serves to cool the stator windings of the motor. Numerous variations are contemplated. For example, in some embodiments only hydraulic thrust bearings are provided, and the mechanical radial bearings are relied upon during normal operation. Conversely, in some embodiments only hydraulic radial bearings are provided, and the mechanical thrust bearings are relied upon during normal operation. The primary coolant water for lubricating the hydraulic bearings can come from various sources. In the illustrative embodiments, dedicated inlets 289, 290 feed the hydraulic bearings, and these inlets 289, 290 may, for example, be fed from a reactor coolant inventory and purification system (RCIPS). In an alternative approach (not shown), passageways can leak primary coolant water from the pump casing surrounding the impeller of the centrifugal pump to the hydraulic bearings. It is also contemplated to employ a dedicated lubricant for the hydraulic bearings in place of the primary coolant water (thus providing a dry motor configuration).

The annular flow turbo-pump provides a compact flow amplification device that fits in the downcomer annulus of a nuclear reactor vessel. It does not include high voltage electrical power connections inside the reactor vessel. The control rod drive mechanisms can be removed for refueling without removing the pumps. As already noted, advantages of this configuration include providing an accessible electrical motor located outside the pressure vessel, and enabling independent performance optimization for the turbo-pumps (or other flow amplification devices located internal to the pressure vessel, such as jet pumps) and the driving hydraulic pumps. Another advantage is that the turbo-pumps, when not driven by the hydraulic pumps, have relatively low flow resistance. This is also true for jet pumps. On the other hand, the hydraulic pumps have a high flow resistance in the non-operational state, but these pumps only carry a small portion (e.g., ⅛) of the total primary coolant flow in the operating state. Thus, during an emergency event, the non-operational pump system exhibits relatively low flow resistance, enabling passive emergency core cooling systems (ECCS) to operate effectively. It should also be noted that while centrifugal pumps are described as the driving hydraulic pumps for operating the flow amplification devices, other electrically driven hydraulic pumps are also contemplated.

In some embodiments, hydraulic bearings are used in the pump motor to provide long operational life. Although disclosed in conjunction with a centrifugal pump impeller located outside the pressure vessel, the hydraulic bearings disclosed herein are also compatible with the in-vessel impeller embodiment of FIGS. 3-26, by using another hydraulic bearing for the splined collar or by using mechanical bearings for the splined collar. The hydraulic bearings are also adaptable to other hydraulic pumps besides centrifugal pumps so long as the impeller provides a forward pulling thrust (tractor thrust), or a rearward force, on the drive shaft to provide a motive force for disengaging the mechanical bearings.

Although the coaxial header was described as using a turbo-pump, it is also contemplated that the coaxial header could be mated to another type of flow amplification device such as a jet-pump.

The preferred embodiments have been illustrated and described. Obviously, modifications and alterations will occur to others upon reading and understanding the preceding detailed description. It is intended that the invention be construed as including all such modifications and alterations insofar as they come within the scope of the appended claims or the equivalents thereof.

We claim:

1. An apparatus comprising:
a nuclear core comprising a fissile material;
a pressure vessel containing the nuclear core immersed in primary coolant water;
a reactor coolant pump (RCP) generating primary coolant flow, the RCP including:
a flow amplification device disposed in the pressure vessel, the flow amplification device having a driving inlet, a pumping inlet, and a pumping outlet; and
an electrically driven centrifugal pump having an inlet receiving primary coolant water from the pressure vessel and an outlet discharging into the driving inlet of the flow amplification device such that the centrifugal pump drives the flow amplification device to pump primary coolant water from the pumping inlet to the pumping outlet; and
a divider disposed in the pressure vessel and separating the pumping inlet of the flow amplification device from the pumping outlet of the flow amplification device.

2. The apparatus of claim 1, wherein the pressure vessel comprises a vertically oriented cylindrical pressure vessel and the apparatus further comprises:
a cylindrical riser oriented coaxially inside the cylindrical pressure vessel;
wherein the divider comprises an annular divider disposed in a downcomer annulus defined between the cylindrical riser and the cylindrical pressure vessel.

3. The apparatus of claim 1, wherein the divider is one of a baffle plate and a manifold plenum chamber.

4. The apparatus of claim 3, wherein the divider is a manifold plenum chamber.

5. The apparatus of claim 4, wherein the flow amplification device is disposed in an opening passing through the manifold plenum chamber such that the flow amplification device and the manifold plenum chamber define an RCP assembly having a suction side and a discharge side separated from the suction side by the RCP assembly, the flow amplification device arranged to pump primary coolant water from the suction side to the discharge side.

6. The apparatus of claim 5, wherein the flow amplification device is secured in the opening of the manifold plenum chamber by fasteners at an installation side selected from the suction side and the discharge side such that the flow amplification device can be removed from the manifold plenum chamber at the installation side by disengaging the fasteners and withdrawing the flow amplification device from the manifold plenum chamber at the installation side.

7. The apparatus of claim 5, wherein the flow amplification device is secured in the opening of the manifold plenum chamber by fasteners at one of the suction side and the discharge side and by a compression seal ring at the other of the suction side and the discharge side.

8. The apparatus of claim 4, wherein the pumping inlet of the flow amplification device is enclosed by the manifold plenum chamber and the pumping inlet draws primary coolant water from inside the manifold plenum chamber.

9. The apparatus of claim 1, wherein the electrically driven centrifugal pump includes an impeller and a casing enclosing the impeller both disposed in the pressure vessel, an electric motor disposed outside the pressure vessel, and a drive shaft running through a wall of the pressure vessel and operatively connecting the electric motor and the impeller.

10. The apparatus of claim 9, wherein the drive shaft has splines mating with a splined collar attached to the impeller.

11. The apparatus of claim 9, wherein the casing includes an inlet scoop having a bearing supporting the drive shaft.

12. The apparatus of claim 1, wherein the electrically driven centrifugal pump includes an impeller and a motor both disposed outside the pressure vessel, and the apparatus further comprises:
a coaxial pipe including an inner passage surrounded by an outer annulus, the coaxial pipe connecting the electrically driven centrifugal pump with the pressure vessel;
wherein one of the inner passage and the outer annulus conveys primary coolant water from the pressure vessel to the electrically driven centrifugal pump; and
wherein the other of the inner passage and the outer annulus conveys primary coolant water pressurized by the electrically driven centrifugal pump from the electrically driven centrifugal pump to the driving inlet of the flow amplification device.

13. The apparatus of claim 12, wherein:
the inner passage conveys primary coolant water from the pressure vessel to the electrically driven centrifugal pump; and
the outer annulus conveys primary coolant water pressurized by the electrically driven centrifugal pump from the electrically driven centrifugal pump to the driving inlet of the flow amplification device.

14. The apparatus of claim 1, wherein a ratio of the fraction of primary coolant flow diverted through the external electrically driven pump to the fraction of primary coolant flow passing into the pumping inlet is typically 1:5 or lower.

15. The apparatus of claim 1, wherein the flow amplification device comprises a turbo pump including a turbine driven by the electrically driven centrifugal pump and an impeller driven by the turbine.

16. The apparatus of claim 15, wherein the turbine of the turbo pump is on the inside of a rotating barrel and the impeller is on the outside of the rotating barrel.

17. The apparatus of claim 1, wherein the electrically driven centrifugal pump includes a drive shaft that is hollow along at least a portion of the drive shaft engaging an electric motor of the electrically driven centrifugal pump, and primary coolant water flows through the hollow portion of the drive shaft to lubricate a hydraulic bearing of the electric motor.

18. An apparatus comprising:
a nuclear core comprising a fissile material;
a pressure vessel containing the nuclear core immersed in primary coolant water; and
an electrically driven pump including an electric motor operatively connected by a drive shaft with an impeller arranged to pump primary coolant water;
wherein the electric motor of the electrically driven pump has at least one hydraulic bearing operating on the drive shaft.

19. The apparatus of claim 18 wherein the at least one hydraulic bearing is lubricated by primary coolant water.

20. The apparatus of claim 19 wherein the drive shaft is at least partially hollow and conveys primary coolant water to the at least one hydraulic bearing.

21. The apparatus of claim 19 wherein the at least one hydraulic bearing includes at least one hydraulic thrust bearing.

22. The apparatus of claim 19 wherein the at least one hydraulic bearing includes at least one hydraulic radial bearing.

23. The apparatus of claim 18 wherein the electric motor further includes at least one mechanical bearing that is disengaged by an axial shift of the drive shaft when the drive shaft is rotating at an operating speed.

24. The apparatus of claim 23 wherein the at least one mechanical bearing includes a mechanical radial bearing having an angled bearing surface that is disengaged the axial shift of the drive shaft when the drive shaft is rotating at the operating speed.

25. The apparatus of claim 18 further comprising:
a flow amplification device disposed in the pressure vessel and driven by the electrically driven pump, the flow amplification device transforming head output by the electrically driven pump into flow.

26. The apparatus of claim 18 further comprising:
a turbo pump disposed in the pressure vessel, the electrically driven pump driving a turbine of the turbo pump to cause the turbo pump to pump primary coolant water in the pressure vessel.

27. An apparatus comprising:
a nuclear core comprising a fissile material;
a pressure vessel containing the nuclear core immersed in primary coolant water;
a reactor coolant pump (RCP) generating primary coolant flow, the RCP including:
a flow amplification device disposed in the pressure vessel, the flow amplification device having a driving inlet, a pumping inlet, and a pumping outlet; and
an electrically driven pump having an inlet receiving primary coolant water from the pressure vessel and an outlet discharging into the driving inlet of the flow amplification device such that the electrically driven pump drives the flow amplification device to pump primary coolant water from the pumping inlet to the pumping outlet; and
a manifold plenum chamber disposed in the pressure vessel and separating the pumping inlet of the flow amplification device from the pumping outlet of the flow amplification device, the manifold plenum of the manifold plenum chamber being in fluid communication with the pumping inlet of the flow amplification device.

28. The apparatus of claim 27, wherein the outlet of the electrical driven pump is connected with the driving inlet of the flow amplification device and is not connected with the manifold plenum of the manifold plenum chamber.

29. The apparatus of claim 27, wherein the flow amplification device is one of a turbo pump and a jet pump.

30. The apparatus of claim 27, wherein the electrically driven pump is a centrifugal pump.
